(19) United States
(12) Patent Application Publication
(10) Pub. No.: US 2026/0177846 A1
(43) Pub. Date: Jun. 25, 2026

(54) AUTOMATIC CALIBRATION OF WAVELENGTH DIVISION MULTIPLEXING OPTICAL MICRO-RING MODULATORS

(71) Applicant: XILINX, INC., San Jose, CA (US)

(72) Inventors: Ahmed ABDELRAHMAN, Champign, IL (US); Zhaowen WANG, Sunnyvale, CA (US); Mayank RAJ, San Jose, CA (US); Stanley Y. CHEN, Cupertino, CA (US)

(21) Appl. No.: 18/990,683

(22) Filed: Dec. 20, 2024

(51) Int. Cl. G02F 1/01; G02F 1/025

(52) U.S. Cl. CPC G02F 1/0147; G02F 1/025

(57) ABSTRACT

Calibration of wavelength division multiplexing (WDM) optical micro-ring modulators (MRMs) may include providing multiple optical signals to a waveguide having multiple MRMs, sweeping heater settings of each MRMs, from high to low, recording drop-port outputs of the first MRM for the corresponding heater settings, while other MRMs are rendered transparent, determining a percentage of the peak-drop port outputs and corresponding off-peak heater settings, discarding off-peak heater settings that are below a tracking margin threshold, and selecting calibrated heater settings for the MRMs from remaining ones of the off-peak heater settings of the respective MRMs. The calibrated heater settings may be selected based on a greedy placement method. Alternatively, additional data may be generated by determining remaining heater settings that cause collisions between adjacent pairs of MRMs, and selecting the calibrated heater settings based on an ordered placement or a sorted placement of the collision settings.

### TECHNICAL FIELD

Examples of the present disclosure generally relate to automatic calibration of wavelength division multiplexing optical micro-ring modulators.

### BACKGROUND

Optical micro-ring modulators (MRMs) are used in high-speed optical links, boosting data throughput with higher bandwidths and wavelength division multiplexing (WDM). A multi-wavelength MRM includes multiple cascaded MRMs, each designed to resonate a respective wavelength. In practice, resonant wavelengths may differ from design specifications due to fabrication mismatches amongst the cascaded MRMs and/or changes in ambient temperature. MRMs may include respective heating elements to control the resonant wavelengths. The MRMs may be calibrated to determine initial heater settings. Thereafter, a tracking controller may adjust the heater settings to compensate for changes in environmental conditions.

### SUMMARY

Techniques for calibration of wavelength division multiplexing optical micro-ring modulators are described. One example is a method that includes providing multiple optical signals to a waveguide that comprises multiple micro-ring modulators (MRMs), sweeping heater settings of a first one of the MRMs, nearest an input of the waveguide, from high to low, recording drop-port outputs of the first MRM for the corresponding heater settings, and rendering the first MRMs transparent to the optical signals subsequent to the sweeping of the heater settings of the first MRM. The method may further include, for each intermediate one of the MRMs, sweeping heater settings of the intermediate MRM from high to low, recording drop-port outputs of the intermediate MRM for the corresponding heater settings, and rendering the intermediate MRM transparent to the optical signals subsequent to the sweeping of the heater setting of the intermediate MRM. The method may further include sweeping heater settings of a last one of the MRMs from high to low, and recording drop-port outputs of the last MRM for the corresponding heater settings, determining peak outputs of the MRMs based on the recorded drop-port outputs of the respective MRMs, and selecting calibrated heater settings for the MRMs based on the peak recorded drop-port outputs of the respective MRMs.

Another example described herein is a system that includes a processor and memory having instructions to cause the processor to control lasers to provide optical signals to a waveguide having cascaded micro-ring resonators (MRMs), control a heater controller to sweep heater settings of each MRM, from high to low, while rendering preceding ones of the MRMs transparent to the optical signals, record drop-port outputs of the MRMs for the corresponding heater settings, determine a percentage of the peak-drop port outputs and corresponding off-peak heater settings, discard off-peak heater settings that are below a tracking margin threshold, and select calibrated heater settings for the MRMs from remaining ones of the off-peak heater settings of the respective MRMs.

Another example described herein is a non-transitory computer readable medium encoded with a computer program that has instructions to cause a processor to control lasers to provide optical signals to a waveguide that comprises cascaded micro-ring resonators (MRMs), control a heater controller to sweep heater settings of each MRM, from high to low, while rendering preceding ones of the MRMs transparent to the optical signals, record drop-port outputs of the MRMs for the corresponding heater settings, determine a percentage of the peak-drop port outputs and corresponding off-peak heater settings, discard off-peak heater settings that are below a tracking margin threshold, determine collision heater settings, from the remaining off-peak heater settings, that cause collisions between adjacent pairs of MRMs, determine distances between the adjacent pairs of MRMs based on the collision heater settings, and select calibrated heater settings for the MRMs from remaining ones of the off-peak heater settings of the respective MRMs based on the distances.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 depicts a calibration system that determines calibrated heater settings for a multi-wavelength micro-ring modulator (MRM) of an integrated circuit device, according to an embodiment.

FIG. 2 depicts an MRM, according to an embodiment.

FIG. 3 depicts multi-wavelength MRM of FIG. 1, according to an embodiment.

FIG. 4 depicts the multi-wavelength MRM of FIG. 1 with a set of eight cascaded MRMs, according to an embodiment.

FIG. 5 depicts a graph of alignments of the MRMs of FIG. 4 to wavelengths, under ideal conditions (e.g., no fabrication variations amongst the MRMs), according to an embodiment.

FIG. 6 depicts a graph of heater power required for the MRMs of FIG. 4 to lock to respective channels, under the ideal conditions, according to an embodiment.

FIG. 7 depicts a graph of simulated center wavelengths of the MRMs of FIG. 4, according to an embodiment.

FIG. 8 depicts graph of heater power versus resonant frequency for an MRM, according to an embodiment.

FIG. 9 depicts graphs of heater power versus transmission through a drop-port of an MRM, according to an embodiment.

FIG. 10 depicts a method of generating calibration data for cascaded MRMs, according to an embodiment.

FIG. 11 depicts a graph of a drop-port output of an MRM as a heater setting of the MRM is swept from high to low, according to an embodiment.

FIG. 12 depicts a method of selecting calibrated heater settings, and evaluating the selected calibrated heater settings, according to an embodiment.

FIG. 13 depicts a greedy placement-based method of selecting calibrated heater settings, according to an embodiment.

FIG. 14 depicts graphs of simulated calibrated heater settings determined for the MRMs of FIG. 4 based on the greedy placement-based method of FIG. 13, according to an embodiment.

FIG. 15 depicts a method of determining relative spacings between pairs of MRMs, according to an embodiment.

FIG. 16A depicts a graph of a collision between a pair of MRMs, according to an embodiment.

FIG. 16B depicts a graph of a collision between another pair of MRMs, according to an embodiment.

FIGS. 17A through 17S depict construction of a collision array based on method 1500, according to an embodiment.

FIG. 18 depicts a graph of MRM alignments, according to an embodiment.

FIG. 19A depicts heater settings (i.e., y-axis) for initial ordered placements of MRMs and corresponding integral points, according to an embodiment.

FIG. 19B depicts the integral points of FIG. 19A, a ramp line, and points representing a difference between integral points and the ramp line, according to an embodiment.

FIG. 19C depicts final ordered placements of the MRMs of FIGS. 19A and 19B, according to an embodiment.

FIG. 20 depicts graphs of simulated calibrated heater settings determined for MRMs based on ordered placement, according to an embodiment.

FIG. 21A depicts a graph of the integral points of FIG. 19A, where two of the integral points are swapped based on sorted placement, according to an embodiment.

FIG. 21B depicts final sorted placements of the MRMs of FIG. 21A, according to an embodiment.

FIG. 22 depicts graphs of simulated calibrated heater settings determined for MRMs based on sorted placement, according to an embodiment.

FIG. 23 depicts the graph of FIG. 19C, according to an embodiment.

FIG. 24 depicts the graph of FIG. 21B, according to an embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe calibration of wavelength division multiplexing optical micro-ring modulators.

Calibration of cascaded MRMs is labor intensive and technically challenging. As an example, during a simultaneous calibration of multiple MRMs, a race condition may arise in which multiple MRMs inadvertently lock to the same wavelength, rendering one or more MRM non-functional and leading to signal interference.

As another example, ensuring proper channel spacing may result in relative high heater settings for one or more of the MRMs. Relatively high heater settings consume extra power, and the heat applied to the MRM may transfer to neighboring MRMs.

Another significant challenge addressed in this work is optimizing heater power during resonance wavelength initialization. In dense WDM (DWDM) systems, the total bandwidth covered by MRMs is designed to span a full free spectral range (FSR). Consequently, some MRMs may miss their assigned channels within the FSR and mistakenly lock to neighboring channels, rendering multiple MRMs ineffective. Alternatively, MRMs may lock to their intended channel in the next FSR by using excessive heater power to shift their resonance wavelength across an entire FSR. Excessive heating in one modulator can affect neighboring MRMs, leading to further inaccuracies and reliability issues. Therefore, balancing heater power across multiple MRMs is crucial for maintaining full functionality, minimizing thermal cross-talk and reducing power consumption.

Systems and methods disclosed herein address these challenges, and others, to ensure accurate wavelength alignment for each MRM while optimizing and balancing heater power of the MRMs to reduce overall power consumption and to reduce thermal cross-talk.

Systems and methods disclosed herein enhance the accuracy and reliability of MRMs, and improve overall efficiency of high-speed optical links, addressing both fabrication-related discrepancies and operational challenges.

In an example, an MRM calibration system, as disclosed herein, determines calibrated heater settings by sweeping heater settings of the MRMs, under specified conditions, determines heater settings that correspond to peak outputs of the MRMs (e.g., absorptions peaks detected from drop-port outputs of the MRMs), determines percentages of the peak outputs and corresponding off-peak heater settings, and discards off-peak heater settings that are below a tracking margin threshold. The calibration system selects the calibrated heater settings from remaining ones of the off-peak heater settings based on one or more methods disclosed herein. In an example, the calibration system selects the lowest remaining heater settings of the MRMs as the calibrated heater settings. In another example, the calibration system selects the calibrated heater settings based on a greedy placement method. In another example, the calibration system determines relative channel spacing between pairs of the MRMs, and selects the calibrated heater settings from the remaining off-peak heater settings based on an ordered placement of the spacings, or based on a sorted placement of the spacings.

The calibration system may determine the relative channel spacing between a pair of MRMs by applying a remaining off-peak heater setting of one of the MRMs to the MRM, and cycling the heater settings of the other MRM through the remaining off-peak heater settings of the other MRM, until the output of the first MRM falls below a minimum output threshold. The heater settings at which the output of the first MRM falls below the minimum output threshold represent the relative channel spacing between the pair of MRMs. The heater settings at which the output of the first MRM falls below the minimum output threshold also represent collision/prohibited heater settings for the pair of MRMs.

Systems and methods disclosed herein determine calibrated heater settings without manual tuning of the heaters.

Systems and methods disclosed herein are scalable for mass production.

Systems and methods disclosed herein are applicable to dense WDM (DWDM) systems (e.g., channel spacing/free spectral range of 200 GHz or less), and coarse WDM (CWDM) systems (e.g., channel spacing greater than 200 GHz).

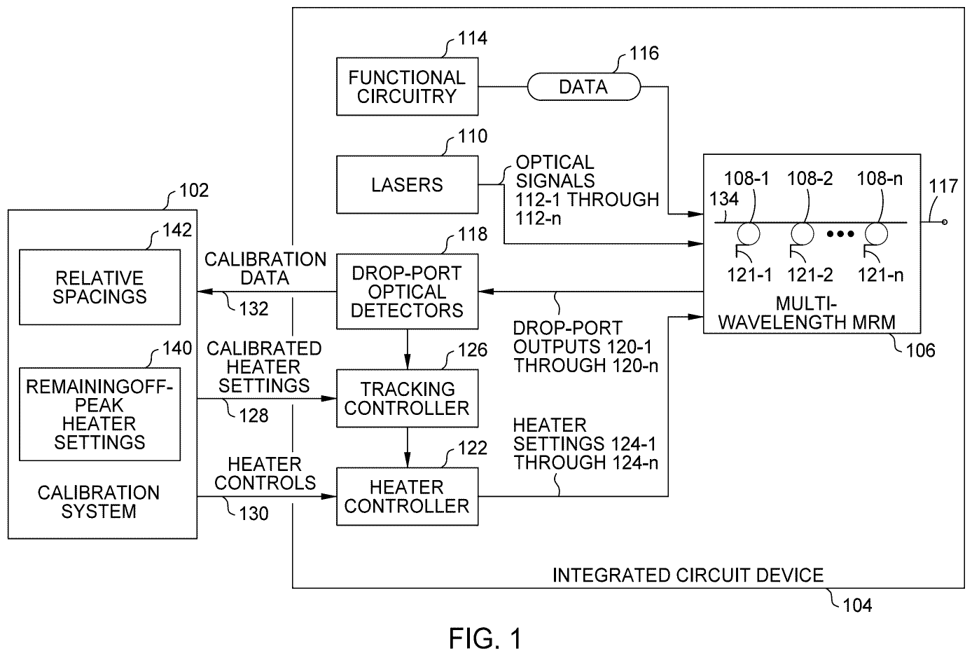

FIG. 1 depicts a calibration system 102 that determines calibrated heater settings 128 for a multi-wavelength MRM 106 of an integrated circuit device 104, according to an embodiment.

In the example of FIG. 1, multi-wavelength MRM 106 includes cascaded optical micro-ring modulators (MRMs) 108-1 through 108-n (collectively MRMs 108). Integrated circuit device 104 further includes lasers 110 that provide optical signals 112-1 through 112-n (collectively, optical signals 112) to multi-wavelength MRM 106, and functional circuitry 114 that provides data 116 to multi-wavelength MRM 106, for modulating optical signals 112. MRMs 108 intensity modulates optical signals 112 based on data 116 to provide a wavelength division multiplexed (WDM) signal 117.

Integrated circuit device 104 further includes drop-port optical detectors 118 that measure drop-port outputs 120-1 through 120-n (collectively, drop-ports outputs 120) of MRMs 108. Drop-port outputs 120 are feedback signals, which may represent a percentage of the optical signals resonating within MRMs 108. A remaining percentage of the optical signals resonating within MRMs 108 may be returned to a waveguide 134 for WDM signal 117.

Integrated circuit device 104 further includes a heater controller 122 that controls heater settings 124-1 through 124-n (collectively, heater settings 124) of MRMs 108. Heaters of MRMs 108 control resonant wavelengths of the MRMs.

Integrated circuit device 104 may further include a tracking controller 126 that controls heater controller 122 based on drop-port outputs 120 during operation (i.e., post-calibration). Tracking controller 126 may control heater controller 122 to maintain desired resonant wavelengths of MRMs 108 under varying environmental conditions (e.g., changing ambient temperature). Tracking controller 126 may use calibrated heater settings 128 as initial heater settings.

Calibration system 102 provides heater controls 130 to heater controller 122 to generate calibration data 132, and determines calibrated heater settings 128 (i.e., initial heater settings) based on calibration data 132. Thereafter, tracking controller 126 may perform subsequent background tracking/calibration.

Calibration data 132 may include drop-port outputs (e.g., voltage and/or current signals indicative of drop-port outputs 120), generated when heater settings 124 are swept over a range of heater settings. In this example, calibration system 102 may determine absorption peaks that correspond to heater settings at which MRMs 108 lock to channels of optical signals 112. Calibration system 102 may determine calibrated heater settings 128 based on the peak power levels, or a percentage thereof for modulation efficiency (e.g., 75%). When calibrated, each MRM 108 is locked to (i.e., resonant at) wavelengths (i.e., channels) of one of optical signals 112 (with no two MRMs locked to the same wavelength), and MRMs 108 intensity-modulate the respective optical signals based on data 116 to provide WDM signal 117. Calibration data 132 may further include drop-port outputs generated by pairs of MRMs 108, and calibration system 102 may determine relative spacings 140 between MRMs 108 based on the drop-port outputs generated by the pairs of MRMs 108. Relative spacings 142 are described further below.

Integrated circuit device 104 may represent one or more integrated circuit dies, printed circuit boards, and/or other integrated circuit-based platform(s). Integrated circuit device 104 may be useful to provide intra-die communications, inter-die communications, rack-to-rack communications, and/or more extended length communications. Integrated circuit device 104, or a portion thereof (e.g., multi-wavelength MRM 106), may include a silicon photonic die.

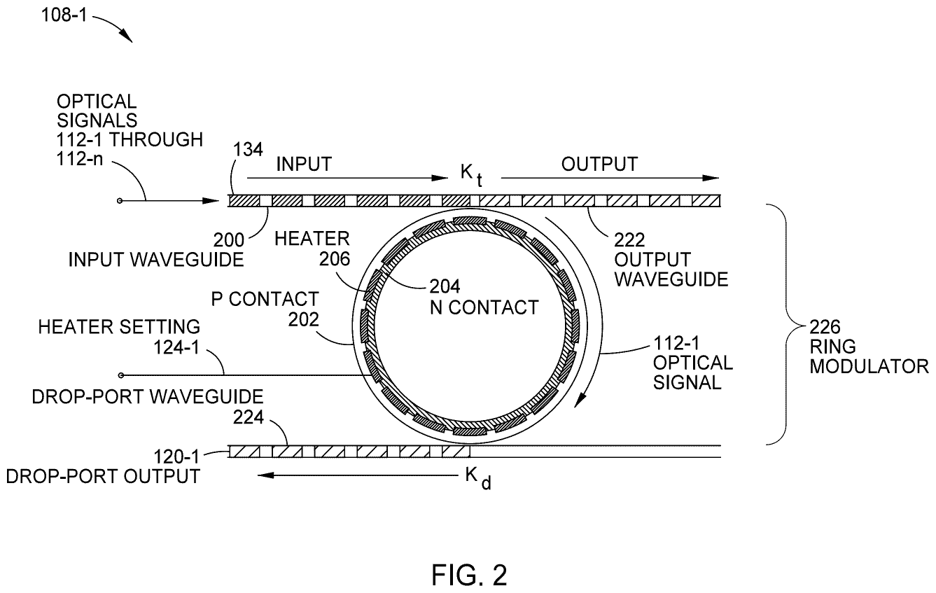

FIG. 2 depicts MRM 108-1, according to an embodiment. In the example of FIG. 2, MRM 108-1 includes waveguide 134 a first portion of which serves as input waveguide 220 to MRM 108-1, and a second portion of which serves as an output waveguide 222 of MRM 108-1. MRM 108-1 further includes drop-port waveguide 224 and corresponding drop-port output 120-1. MRM 108-1 further includes a ring modulator 226 optically coupled to waveguide 134 and drop-port waveguide 224. When optical signal 112-1 is transmitted into waveguide 134, part of optical signal 112-1 couples into ring modulator 210 due to the phenomenon of the evanescent field, provided that ring modulator 210 is resonant at the wavelength of the optical signal. The portion of optical signal 112-1 within ring modulator 210 builds up in intensity over multiple round-trips due to constructive interference and total internal reflection (TIR). Portions of optical signal 112-1 within ring modulator 226 are output to output waveguide 222 and drop-port waveguide 224 via optical coupling (e.g., 75% to output waveguide 222 and 25% to drop-port waveguide 224). Ring modulator includes a P-type contact 202 and an N-type contact 204 to modulate the portion of optical signal 112-1 within ring modulator 226. Ring modulator further includes a heater 206.

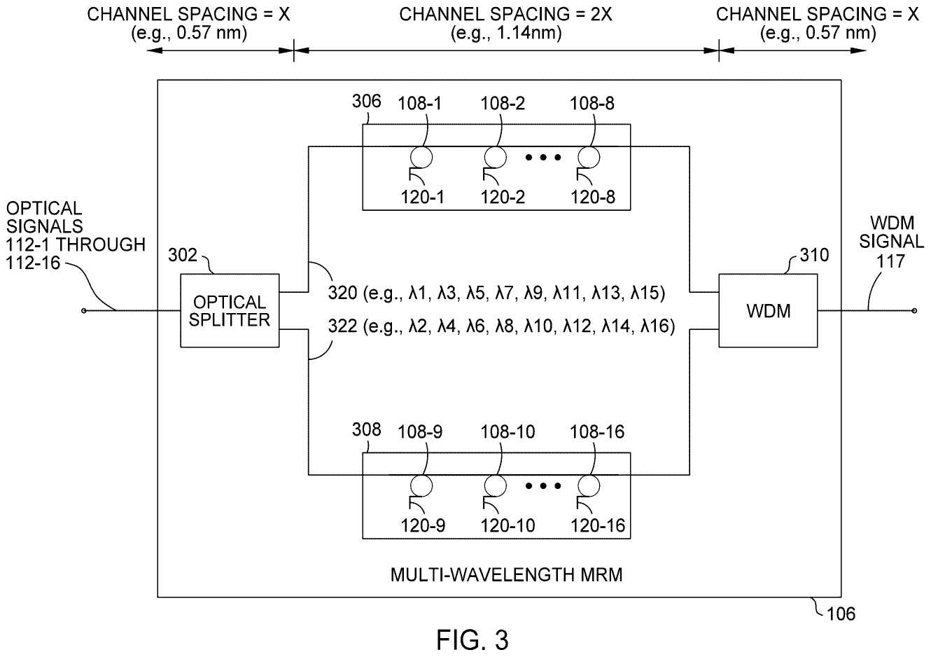

FIG. 3 depicts multi-wavelength MRM 106, according to an embodiment. In the example of FIG. 3, multi-wavelength MRM 106 is depicted as a multi-path 16-channel wavelength-division multiplexing (WDM) optical transmitter. In FIG. 3, multi-wavelength MRM 106 includes an optical splitter 302 (e.g., an optical de-multiplexer) that provides odd-numbered optical signals 320 (i.e., 112-1, 112-3, . . . 112-15) to a first path 306 of cascaded WDMs, and even-numbered optical signals 322 (i.e., 112-2, 112-4, . . . 112-16) to a second path 308 of cascaded WDMs. Separating optical signals 112 into multiple paths may be useful to increase channel spacing between the wavelengths of optical signals 112 for calibration and modulation. In the example of FIG. 3, multi-wavelength MRM 106 further includes a wavelength division multiplexer (WDM) 310 that combines modulated outputs of paths 306 and 308 to provide WDM signal 117.

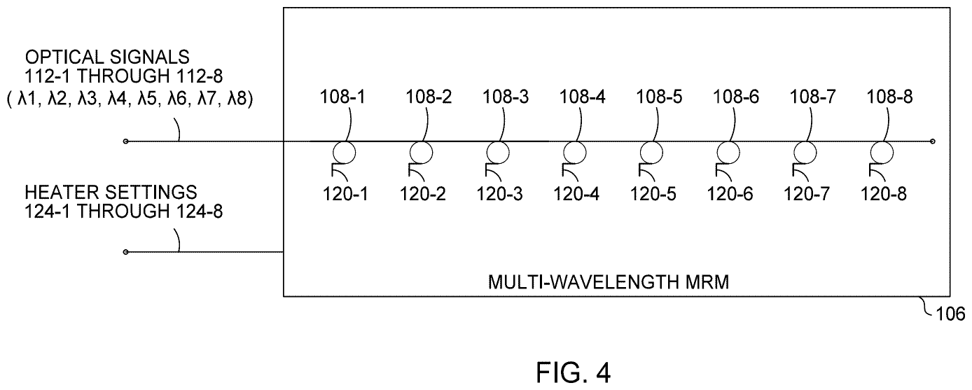

FIG. 4 depicts multi-wavelength MRM 106 with a set of eight cascaded MRMs, 108-1 through 108-8, according to an embodiment. MRM 106 may include multiple sets of cascaded MRMs, such as depicted in FIG. 3. Calibration system 102 and methods of calibration are described below with reference to the example of FIG. 4. Calibration system 102 and methods of calibration described below are not, however, limited to the example of FIG. 4.

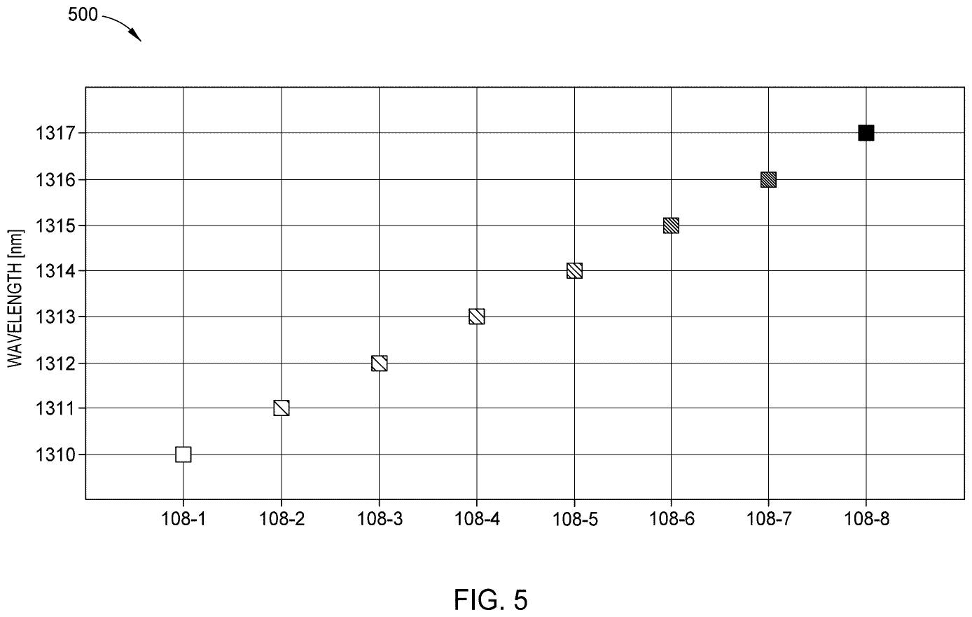

FIG. 5 depicts a graph 500 of alignments of MRMs 108-1 through 108-8 to wavelengths, according to an embodiment. The example of FIG. 4 represents an ideal situation (e.g., no fabrication variations amongst MRMs 108-1 through 108-8) in which resonant wavelengths of MRMs 108 are equally spaced (e.g., 1 nm apart, with an FSR of 8 nm).

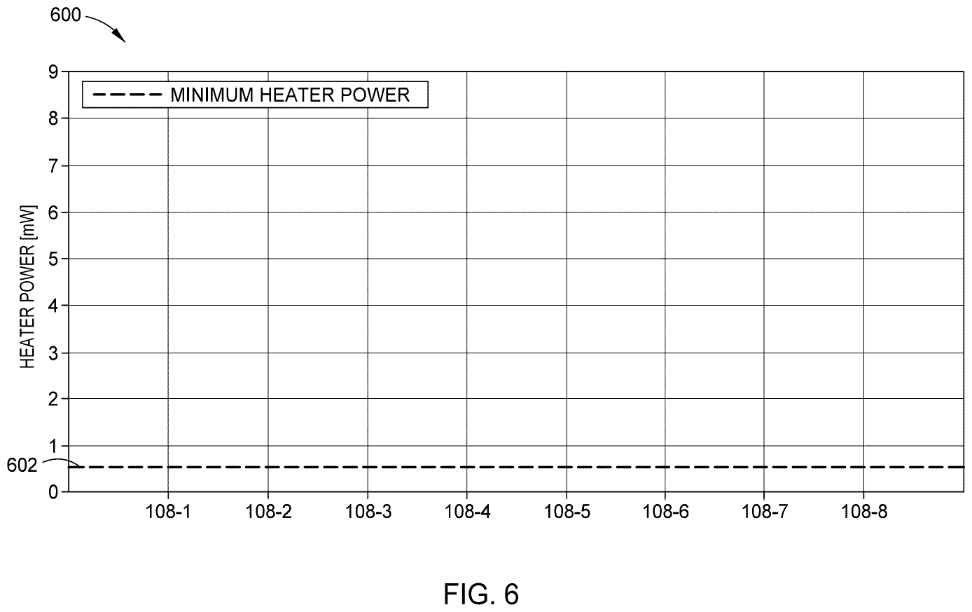

FIG. 6 depicts a graph 600 of heater power required for MRMs 108-1 through 108-8 to lock to respective channels (i.e., wavelengths of optical signals 112-1 through 112-8), for the ideal situation (e.g., no fabrication variations amongst MRMs 108-1 through 108-8), according to an embodiment. A minimum heater power may be set to provide a tracking margin 604.

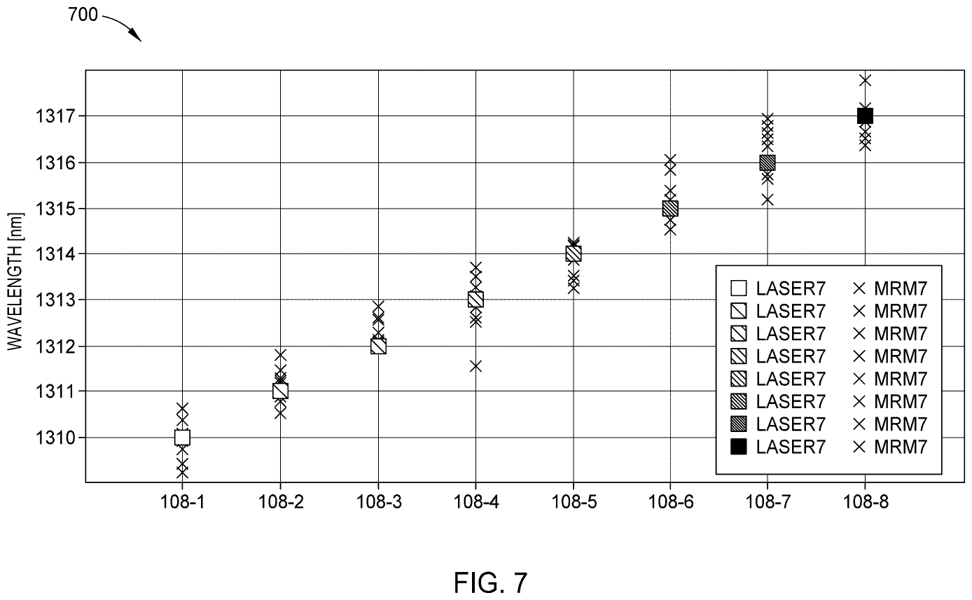

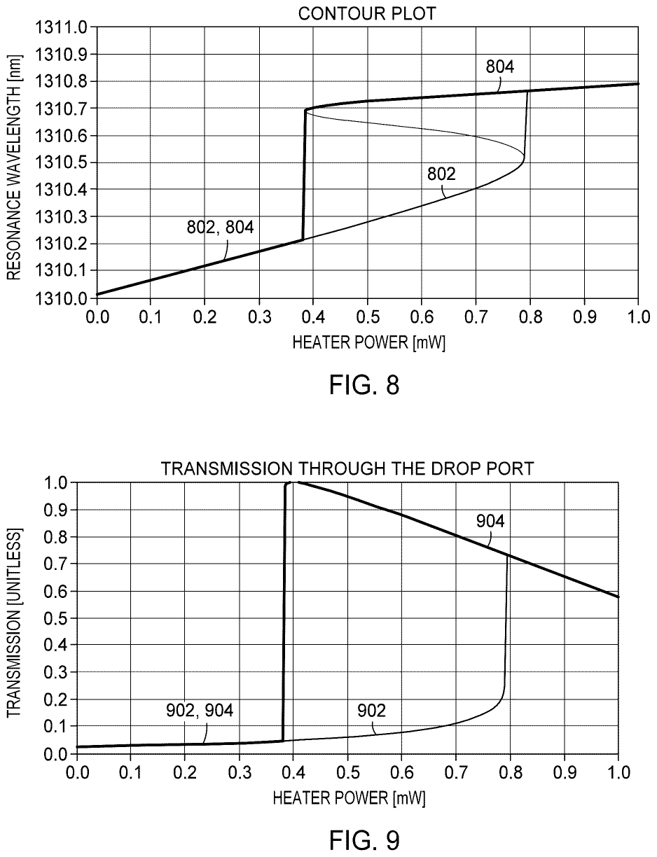

FIG. 7 depicts a graph 700 of simulated center wavelengths of MRMs 108-1 through 108-8 (i.e., 10 samples), according to an embodiment. In the example of FIG. 8, the center wavelengths deviate from the desired resonant wavelengths (e.g., of 0.5 nm, standard deviation), which may be due to fabrication mismatches amongst MRMs and/or amongst photodiodes of drop-port optical detectors 118. The deviations may cause one or more of MRMs 108 to overlap with a neighboring MRM, leading to a wavelength race condition and/or excessive heater power to shift the resonant wavelength of an MRM by channel/FSR.

Calibration system 200 and methods disclosed below, automatically align the MRMs to a laser grid and optimize the heater power distribution to reduce overall power usage and reduce thermal interactions amongst the MRMs. Calibration system 200 and methods disclosed below, enhance the accuracy and reliability of the MRMs, and improves overall efficiency of high-speed optical links, addressing both fabrication-related discrepancies and operational challenges.

FIG. 8 depicts graph 802 and 804 of heater power versus resonant frequency for an MRM, according to an embodiment. Graph 802 represents heater power versus resonant frequency when heater settings 124 are swept from low to high. Graph 804 represents heater power versus resonant frequency when heater settings 124 are swept from high to low. As illustrated in FIG. 8, sweeping heater settings 124 from low to high (i.e., graph 802) leads to increased self-heating (i.e., heating not due to heater 206 in FIG. 2), which causes hysteresis. Conversely, sweeping heater settings 124 from high to low results in greater transmission/absorption. Calibration system 102 and methods disclosed below may generate calibration data 132 by sweeping heater settings 124 from high to low.

FIG. 9 depicts graphs 902 and 904 of heater power versus transmission through a drop-port 121 of an MRM 108, according to an embodiment. Graph 902 represents heater power versus transmission when heater power is swept from low to high. Graph 904 represents heater power versus transmission when heater power is swept from high to low. Graph 902 illustrates the hysteresis described above when heater power is swept from low to high.

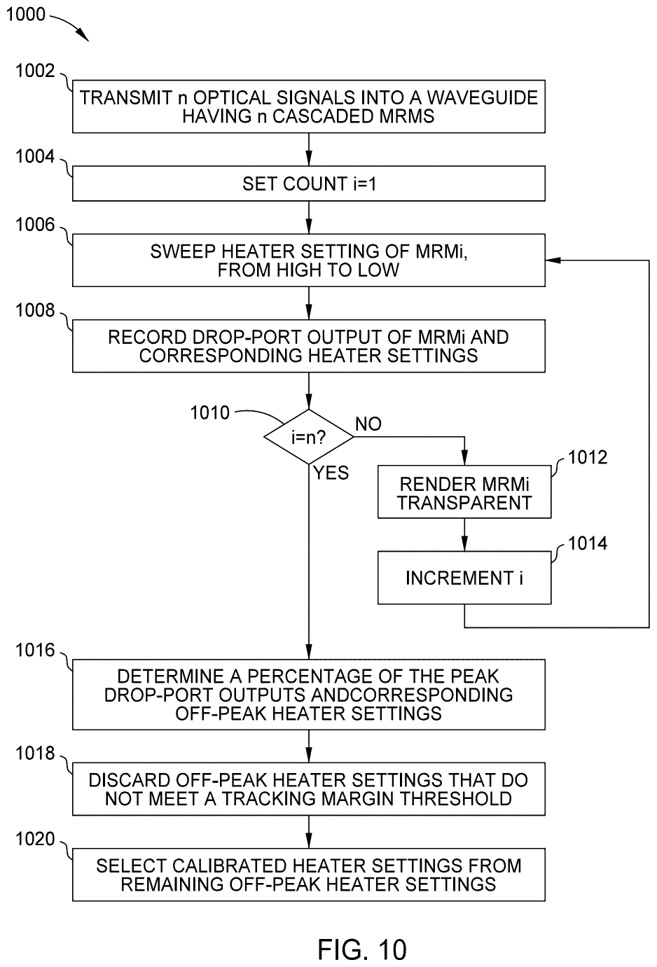

FIG. 10 depicts a method 1000 of generating calibration data 132 for cascaded MRMs 108, according to an embodiment.

At 1002, lasers 110 provide optical signals 112-1 through 112-8 to multi-wavelength MRM 106.

At 1004, calibration system 102 initializes a count (e.g., sets a count i to 1).

At 1006, calibration system 102 controls heater controller 122 to sweep heater setting 104-i of MRM 108-i (i.e., heater setting 104-1 of MRM 108-1) from high to low.

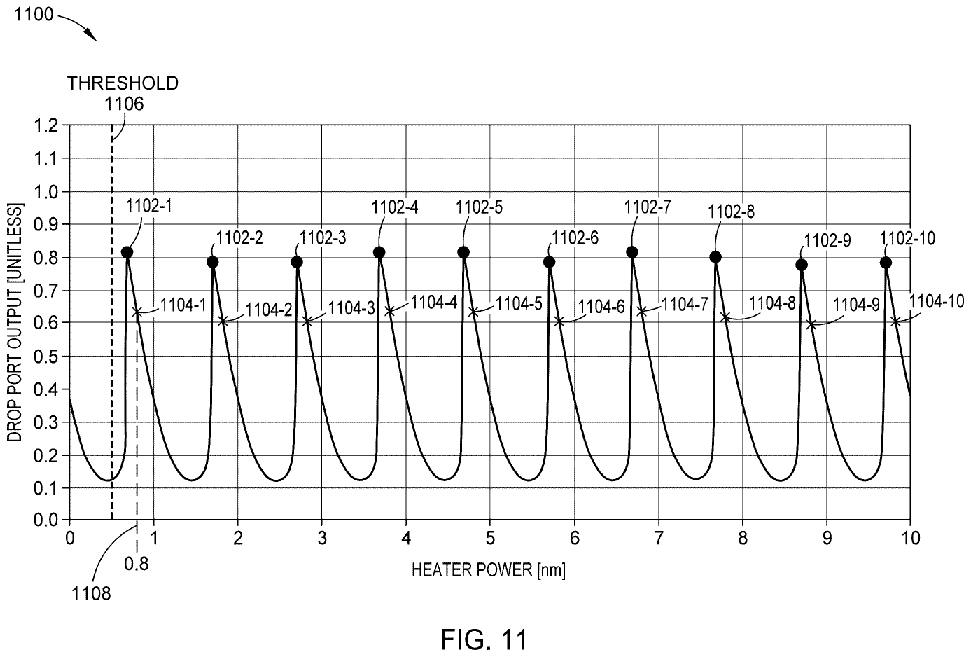

At 1008, calibration system 102 records drop-port output 120-i (i.e., 120-1 of MRM 108-1), as calibration data 132 for MRM-i. FIG. 11 depicts a graph 1100 of drop-port output 120-i, as heater controller 122 sweeps heater setting 124-i from high to low, according to an embodiment. In graph 1100 peaks 1102-1 through 1102-10 (collectively, peaks 1120) represent heater settings at which MRM-i resonates at the wavelength of one of optical signals 112 (i.e., heater settings at which MRM-i and a laser channel align with one another). In an ideal situation (e.g., no fabrication variations amongst MRMs 108), peaks 1102-1 through 1102-8 represent wavelengths of optical signals 102-1 through 102-8, respectively, peak 1102-9 represents the wavelength of optical signal 102-1 after one FSR, and peak 1102-10 represents the wavelength of optical signal 102-2 after one FSR

Drop-port optical detectors 118 may provide calibration data 132 as measures of luminosity, not wavelength. In such a situation, calibration system 102 is unable associate peaks 1102 or points 1104 with specific optical signals 112. This poses a calibration challenge, solutions for which are provided further below.

At 1010, if i is less than n, processing proceeds to 1012, where calibration system 102 renders MRM-i transparent to wavelengths of optical signals 112. In an example, calibration system 102 controls heater controller 122 to set heater setting 104-i sufficiently high to move the resonant wavelength of MRM-i above the wavelengths of optical signals 112. Calibration system 102 is not limited to the foregoing example.

At 1014, calibration system 102 increments count i, and processing returns to 1006, to generate calibration data 132 from MRM 108-2.

Returning to 1010, when i=n (i.e., when a graph 1100 is generated for each of MRMs 108), processing proceeds to 1016, where calibration system 102 determines a percentage of peaks 1102 and corresponding off-peak heater settings. In the example of FIG. 11, calibration system 102 may determine 75% of peaks 1102, denoted here as points 1104-1 through 1104-10. In other examples, calibration system 102 may determine a different percentage.

At 1018, calibration system 102 discards points 1204 for which off-peak heater settings are below a tracking margin threshold 1206.

At 1020, calibration system 102 selects calibrated heater settings 128 for MRMs 108 from remaining off-peak heater settings of the respective MRMs.

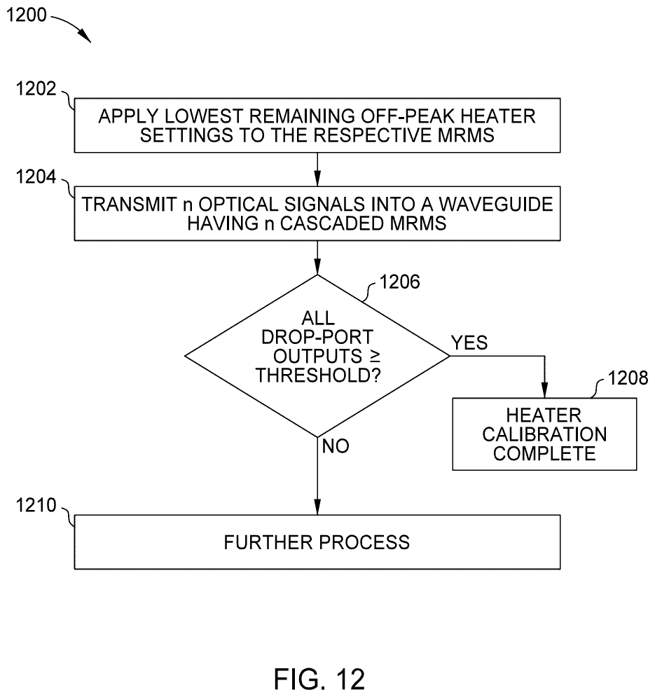

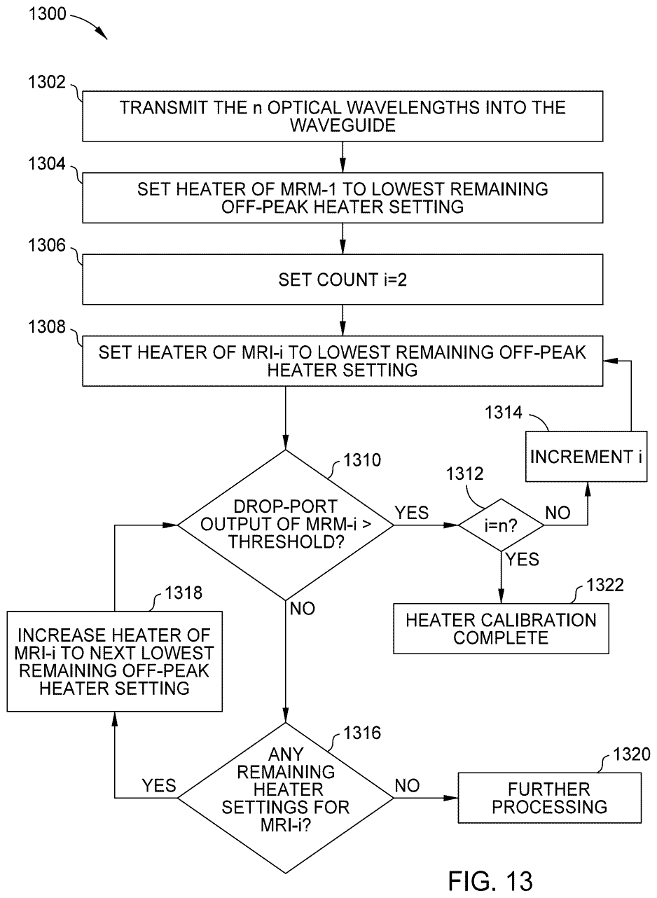

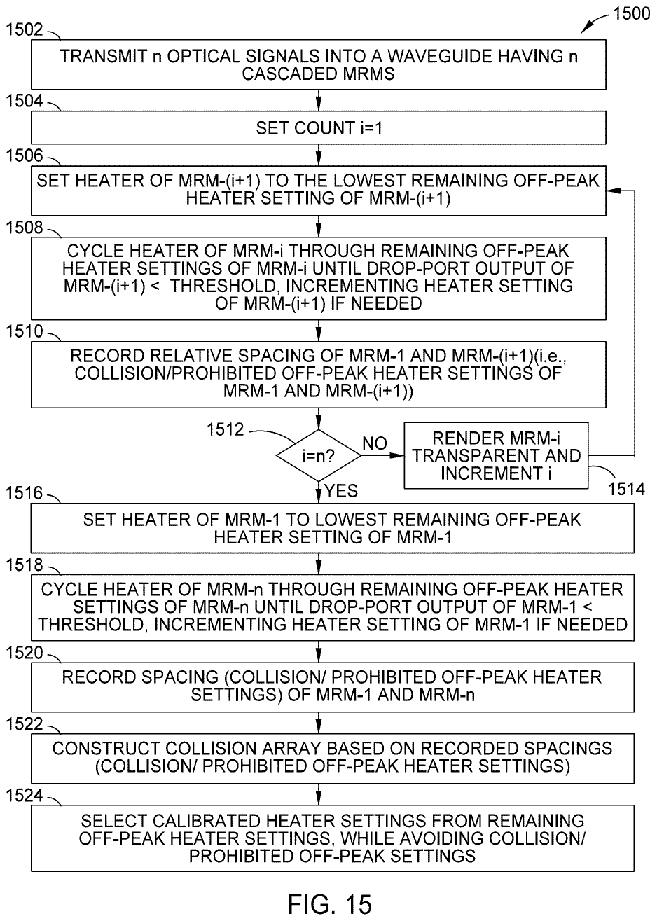

Calibration system 102 may select calibrated heater settings 128 based on one or more methods disclosed below with reference to FIGS. 12, 13, and/or 15. In an example, calibration system 102 selects calibrated heater settings 128 based on the method of FIG. 12. In another example, calibration system 102 selects calibrated heater settings 128 based on the methods of FIGS. 12 and 13. In another example, calibration system 102 selects calibrated heater settings 128 based on the methods of FIGS. 12, 13, and 15. In another example, calibration system 102 selects calibrated heater settings 128 based on the method of FIG. 15 (i.e., omitting/bypassing the methods of FIGS. 12 and 13).

FIG. 12 depicts a method 1200 of selecting calibrated heater settings 128, and evaluating the selected calibrated heater settings, according to an embodiment.

At 1202, calibration system 102 controls heater controller 122 to apply the lowest remaining off-peak heater setting of each MRM 108 to the respective MRM 108. In the example of FIG. 12, heater controller 122 applies off-peak heater setting 1208 (e.g., 0.8) to MRM-i.

At 1204, lasers 110 provide optical signals 112-1 through 112-8 to multi-wavelength MRM 106.

At 1206, calibration system 102 determines whether drop-port outputs 121 of MRMs 108 meet a minimum output threshold (e.g., a minimum output intensity threshold). The drop-port outputs of MRMs 108 will meet the minimum output threshold if each MRM 108 is resonant at a wavelength of one of optical signals 112, and no more than one MRM 108 is resonant at any one of the wavelengths (i.e., each MRM 108-1 through 108-n is aligned with a unique one of optical signals 112, but not necessarily a respective one of optical signals 112-1 through 112-n). Conversely, if two or more of MRMs 108 are resonant at the wavelength of the same optical signal 112, the drop-port output 121 of a first one of the MRMs may meet the minimum output threshold, but the drop-port output 121 of a subsequent MRM locked to the same wavelength will not meet the minimum output threshold.

If the drop-port outputs 111 of MRMs 108 meet the minimum output threshold, processing proceeds to 1208, where calibration system 102 provides the off-peak heater settings applied at 1202 to tracking controller 126, as calibrated heater settings 128.

If the drop-port output 121 of any of MRMs 108 does not meet the minimum output threshold (i.e., indicating a collision of resonant wavelengths of two more MRMs), processing proceed to 1210 for further processing. The further processing at 1210 may include a greedy placement method described below with reference to FIG. 13, an ordered placement method described further below with reference to FIG. 15, and/or a sorted placement method described further below with reference to FIG. 15.

FIG. 13 depicts a greedy placement-based method 1300 of selecting calibrated heater settings 128, according to an embodiment.

At 1302, lasers 110 provide optical signals 112-1 through 112-8 to multi-wavelength MRM 106.

At 1304, calibration system 102 controls heater controller 122 to apply the lowest remaining off-peak heater setting of MRM 108-1, to MRM 108-1. In the example of FIG. 13, heater controller 122 applies off-peak heater setting 1308 (e.g., 0.8) to MRM-1.

At 1306, calibration system 102 sets count i to 2.

At 1308, calibration system 102 controls heater controller 122 to apply the lowest remaining off-peak heater setting of MRM 108-i (i.e., MRM 108-2 in a first iteration), to MRM 108-i.

At 1310, calibration system 102 compares drop-port output 121-i to a minimum output threshold (i.e., drop-port output 121-2 of MRM 108-2 in the first iteration). Alternatively, calibration system 102 may compare drop-port outputs 121-1 through 121-i to the minimum intensity threshold. As described below, however, MRMs 108 that precede MRM 108-i are necessarily locked to different wavelengths such that the drop-port outputs of the preceding MRMs may be assumed to meet the minimum intensity threshold. If MRM-1 through MRM-i are aligned to different wavelengths, drop-port outputs 121-i will meet the minimum intensity threshold, and processing proceeds to 1312.

At 1312, if the count i is less than n (e.g., n=8 in this example), processing proceeds to 1314, where calibration system, 102 increments the count i. Processing then returns to 1308, where calibration system 102 controls heater controller 122 to apply the lowest remaining off-peak heater setting of the next MRM (i.e., MRM 108-3 in a second iteration).

Returning to 1310, if drop-port output 121-i does not meet the minimum intensity threshold, processing proceed to 1316.

At 1316, if there are any remaining off-peak heater settings for MRM 108-i, processing proceeds to 1318, where calibration system 102 controls heater controller 122 to apply the next lowest remaining off-peak heater setting of MRM 108-i. Processing then returns to 1310. If there are no remaining off-peak heater settings for MRM 108-i, processing proceeds from 1316 to 1320, where calibration system 102 may perform additional post processing. The additional processing may include generating additional calibration data, such as described further below with reference to FIG. 15.

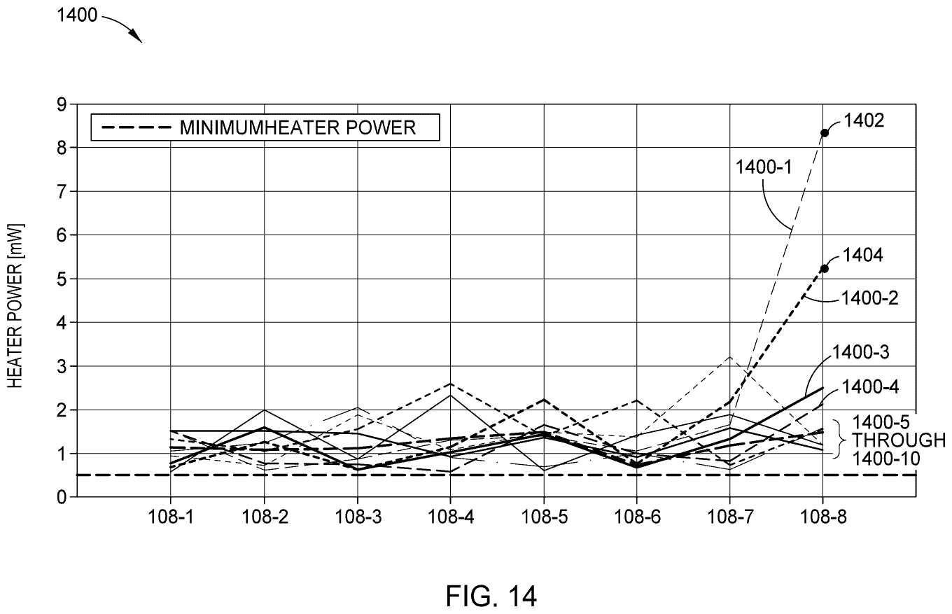

Returning to 1312, when the count i reaches than n, heater calibration is complete, and calibration system 102 provides the off-peak heater settings of 1308 and/or 1318 to tracking controller 126. In some situations, greedy placement method 1300 may result in relatively high heater settings for subsequent MRMs 108, such as illustrated in FIG. 14. FIG. 14 depicts graphs 1400-1 through 1400-10 of simulated calibrated heater settings 128 determined for MRMs 108 based on greedy placement-based method 1300, according to an embodiment. Each of graphs 1400-1 through 1400-10 represent a respective simulation run. In the example of FIG. 14, a point 1402 of graph 1400-1 and a point 1404 of graph 1400-2 show relatively high calibrated heater settings 128 for MRM 108-8. Relatively high heater settings may increase power consumption, and the corresponding heat may spread to neighboring MRMs, which may impact resonant wavelengths of the neighboring MRMs.

FIG. 15 depicts a method 1500 of determining relative spacings 142, according to an embodiment. As described below, method 1500 determines off-peak heater settings for pairs of MRMs 108 that result in the pairs of MRMs locking to the same wavelength (i.e., intentionally locking pairs of MRMs to the same channel to result in a failure in the trailing MRM). The off-peak heater settings may be referred to as collision heater settings or prohibited heater settings. The off-peak heater settings may correspond to relative positions/distances between the pairs of MRMs, with respect to channel spacing/FSR. Method 1500 may be performed in conjunction with method 1000 (e.g., simultaneous with and/or subsequent to method 1000). Method 1500 may be performed further in conjunction with methods 1200 and/or method 1300. Alternatively, method 1500 may be performed without method 1200 and/or method 1300.

At 1502, lasers 110 provide optical signals 112-1 through 112-n to multi-wavelength MRM 106.

At 1504, calibration system 102 sets count i to 1.

At 1506, calibration system 102 controls heater controller 122 to apply the lowest remaining off-peak heater setting of MRM 108-(i+1), to MRM 108-(i+1), (i.e., MRM 108-2 in the first iteration).

At 1508, calibration system 102 controls heater controller 122 to cycle through the remaining off-peak heater setting of MRM 108-i (i.e., MRM 108-1 in the first iteration), until the drop-port output of MRM 108-(i+1) falls below the minimum intensity threshold. The drop-port output of MRM 108-(i+1) will fall below the minimum intensity threshold when MRM 108-i and 108-(i+1) are locked to (i.e., collide at) the same wavelength.

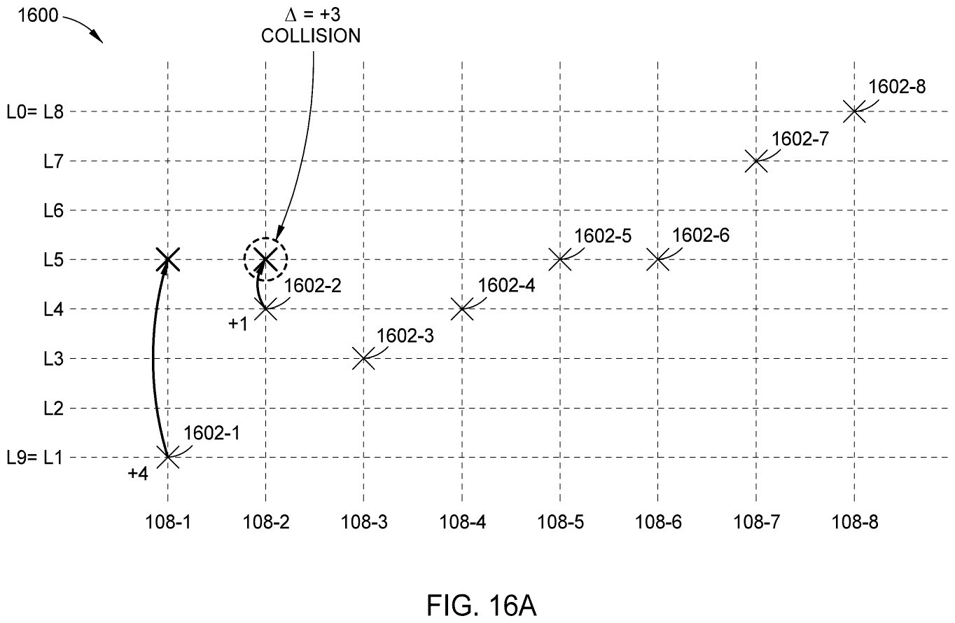

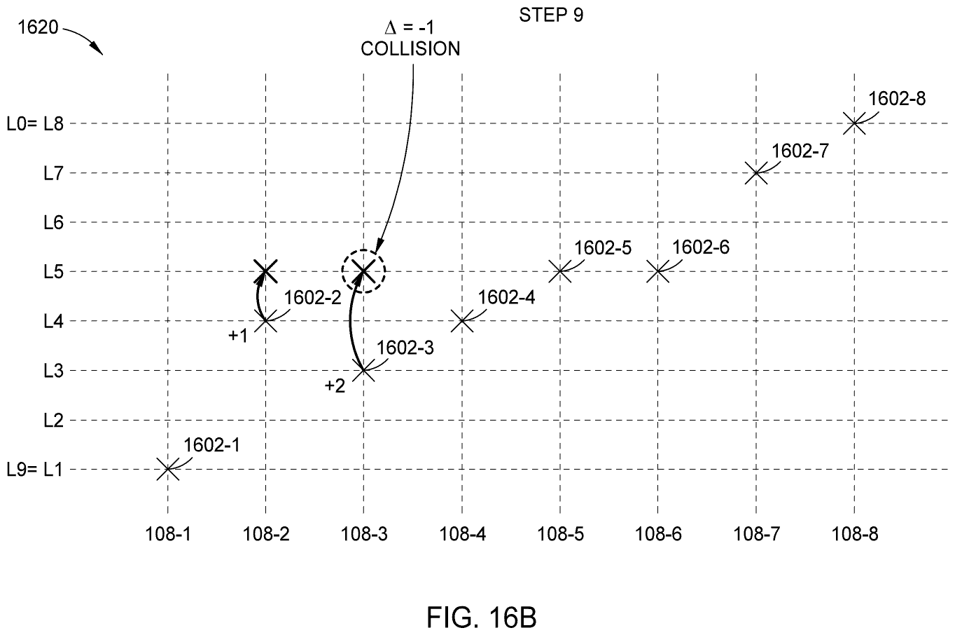

FIG. 16A depicts a graph 1600 of a collision between MRMs 108-1 and 108-2, according to an embodiment. Graph 1600 includes points 1602-1 through 1602-8 that represent wavelengths to which MRMs 108-1 through 108-8 lock at the respective lowest remaining heater settings. In this example, MRM 108-1 locks at λ1 (e.g., the wavelength of optical signal 112-1), when at the lowest remaining off-peak heater setting of MRM 108-1. MRM 108-2 locks at >4 (e.g., the wavelength of optical signal 112-4), when at the lowest remaining off-peak heater setting of MRM 108-2.

Under ideal conditions, MRM 108-2 locks at 2 (e.g., the wavelength of optical signal 112-2). For calibration and operational purposes, however, MRMs 108-1 through 108-8 do not need to lock on respective ones of optical signals 112-1 through 112-8. Rather, each of MRMs 108-1 through 108-8 need to lock on one of optical signals 112-1 through 112-8, with no two MRMs locking on the same optical signal.

Further in the example of FIG. 16A, MRMs 108-1 and 108-2 collide at λ5 (e.g., the wavelength of optical signal 112-5), when the heater setting of MRM 108-1 is raised to the fourth remaining off-peak heater setting of MRM 108-1 and the heater setting of MRM 108-2 is raised to the second remaining off-peak heater setting of MRM 108-2.

In some situations, the heater setting of MRM-(i+1) may also be adjusted (e.g., increased to one or more remaining heater settings of MRM-(i+1). As an example, FIG. 16B depicts a graph 1620 of a collision between MRMs 108-2 and 108-3, according to an embodiment. In the example of FIG. 16B, when MRMs 108-2 and 108-3 are at the respective lowest remaining heater settings, MRMs 108-2 resonates at wavelength L4 and MRM 108-3 resonates at wavelength L3 (which is unknown prior to 1508). Further in the example of FIG. 16B, collision occurs when the heater setting of MRM 108-2 (i.e., MRM-i) is increased to the next remaining heater setting of MRM 108-2 and the heater setting of MRM 108-3 (i.e., MRM-(i+1)) is increased by two remaining heater settings of MRM 108-3. The difference in the changes to the heater settings (i.e., 1-2=−1) indicates that, at the lowest respective remaining heater settings, MRM 108-2 resonates 1 channel above MRM 108-3 (i.e., negative difference detection).

In practice, a collision may be instituted at any wavelength. The goal is to determine the difference (delta) between adjacent MRMs. In another example, a collusion may be instituted at L5 (i.e., with a delta of −1), by moving MRM 108-2 by 1 grid, and MRM 108-3 by 2 grids. Alternatively, the heater setting of MRM 108-3 may be retained at the lowest remaining heater setting of MRM 108-3, and the heater setting of MRM 108-2 may be increased by seven remaining heater settings of MRM 108-2 to cause a collision at wavelength L3 (L4+7=L10, L10 wraps to L3). The former approach, depicted in FIG. 16B, may reduce calibration time.

In an example, calibration system 102 may initially increase the heater setting of MRM 108-2 (i.e., MRM-i) by up to one half of the FSR (e.g., 4 wavelengths/remaining heater settings. If no collision is detected at that point, calibration system 102 may increase the heater setting of MRM 108-3 (i.e., MRM-(i+1)), as depicted in FIG. 16B.

At 1510, calibration system 102 records the off-peak heater settings of MRM 108-i and 108-(i+1) as relative spacings 142 (i.e., relative distances between the respective pairs of MRMs 108, in terms of numbers of channels or wavelengths of optical signals 112). As described further below, calibration system 102 may use relative spacings 142 to determine relative distances amongst any pair of, and/or amongst all MRMs 108. Calibration system 102 may treat relative spacings 142 prohibited heater settings for the respective pair of MRMs.

At 1512, if i is less than n, processing proceeds to 1514, where calibration system 102 increments renders MRM 108-i transparent to wavelengths of optical signals 112-1 through 112-n, and increments count i. Processing then returns to 1504 to determine collision/prohibited heater settings for a next pair of MRMs (i.e., MRMs 108-2 and MRM 108-3 in a second iteration).

When i equals n at 1512, processing proceeds to 1516 to determine collision/prohibited heater settings for MRMs 108-1 and 108-n.

At 1516, lasers 110 provide optical signals 112-1 and 112-n to multi-wavelength MRM 106.

At 1518, calibration system 102 controls heater controller 122 to apply the lowest remaining heater setting of MRM 108-1 to MRM 108-1.

At 1520, calibration system 102 controls heater controller 122 to cycle the heater setting of MRM 108-n, through the remaining off-peak heater settings of MRM 108-n, until the drop-port output of MRM 108-1 falls below the threshold. The drop-port output of MRM 108-1 will fall below the threshold when MRM 108-1 and 108-n are locked to (i.e., collide at) the same wavelength.

At 1522, calibration system 102 records the off-peak heater settings of MRM 108-1 and 108-n as relative spacings 142.

At 1524, calibration system 102 processes the collision/prohibited heater settings to determine calibrated heater settings 128, such that the collision/prohibited heater settings are avoided.

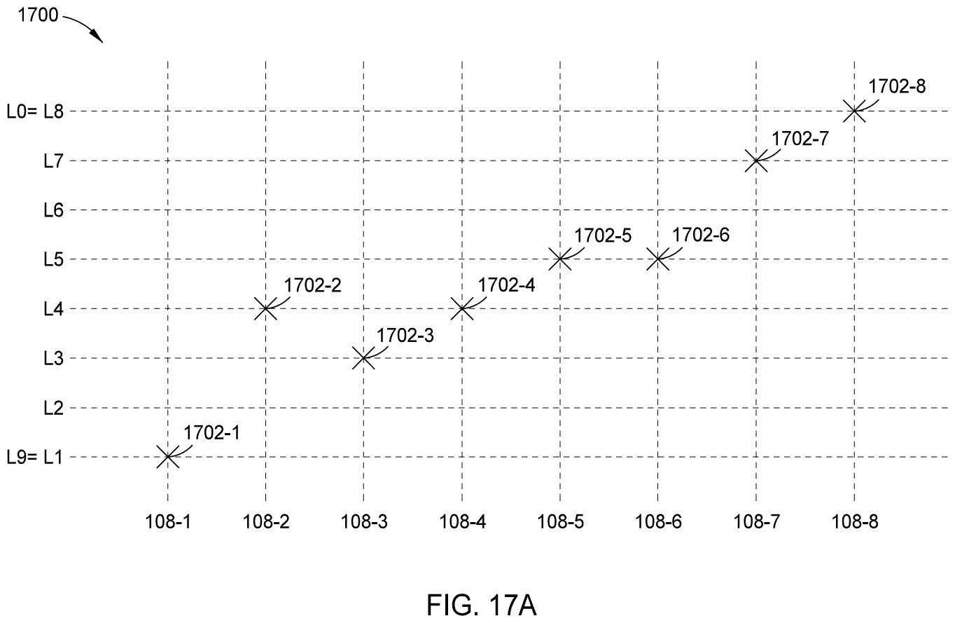

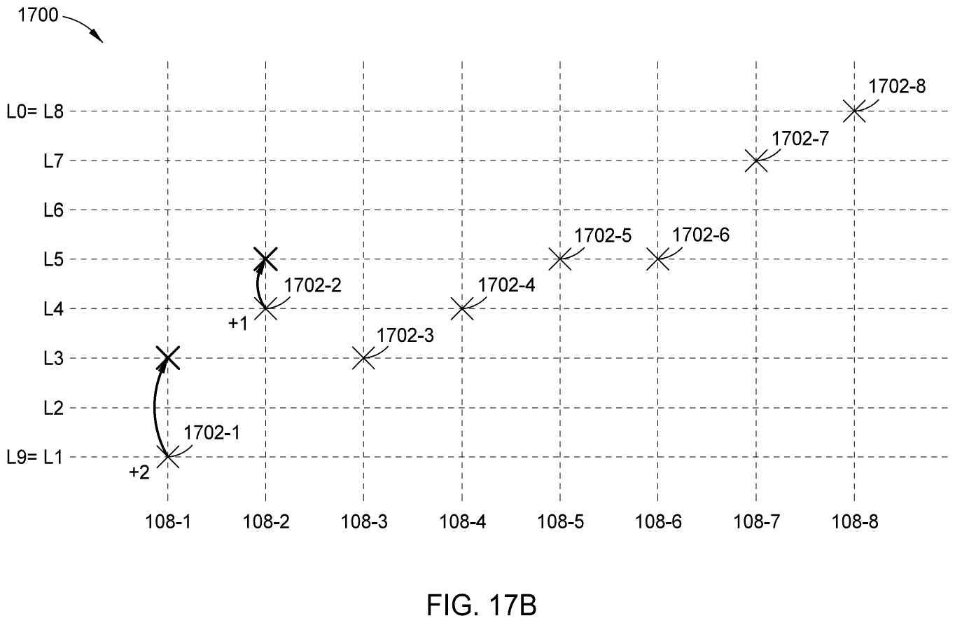

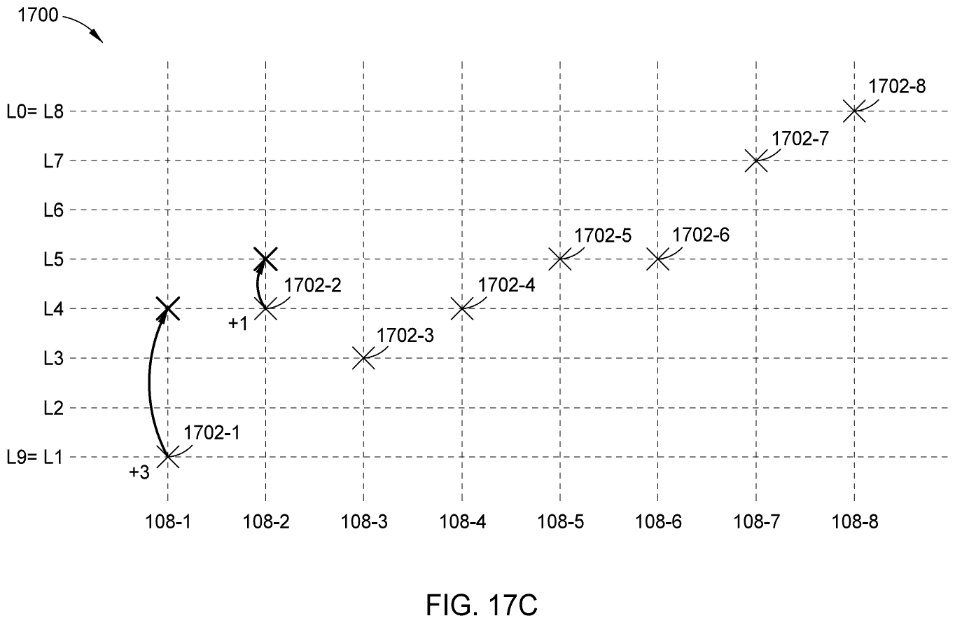

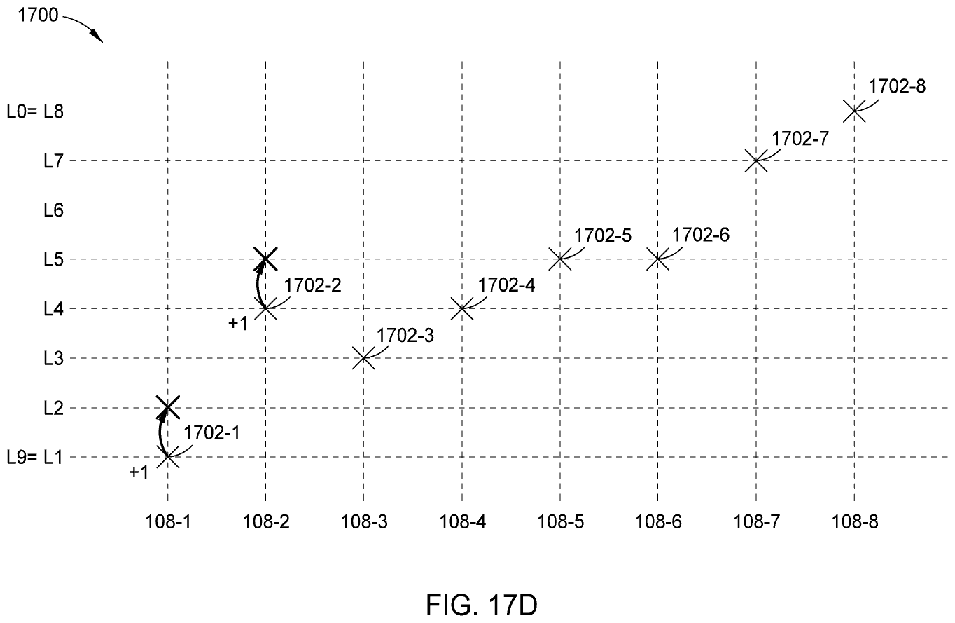

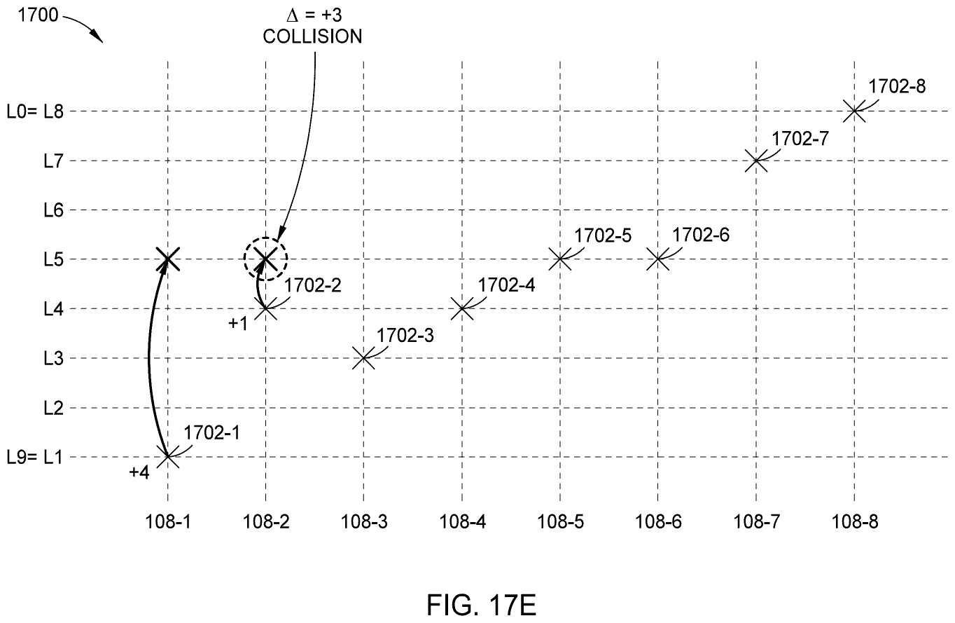

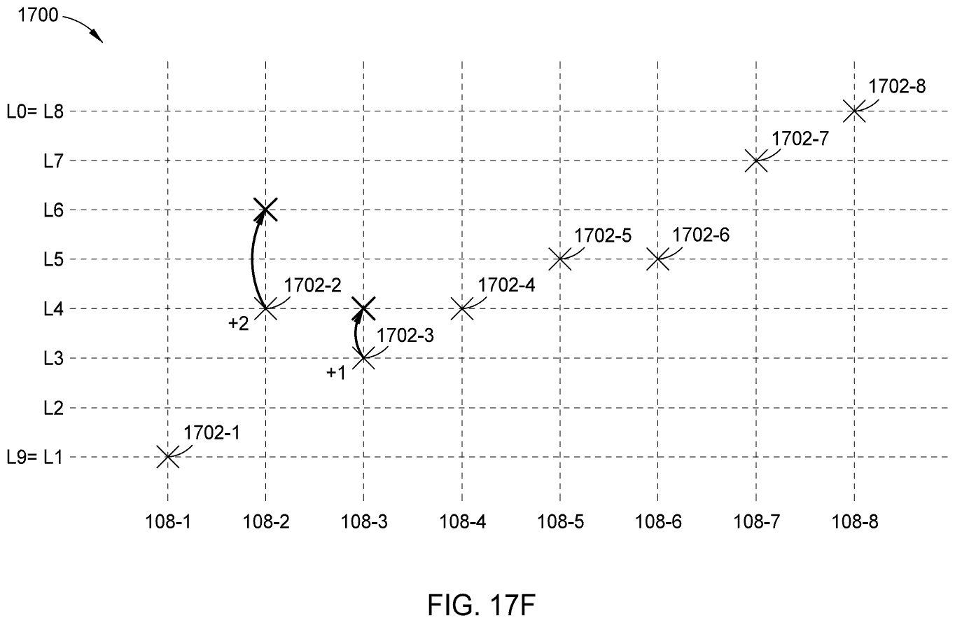

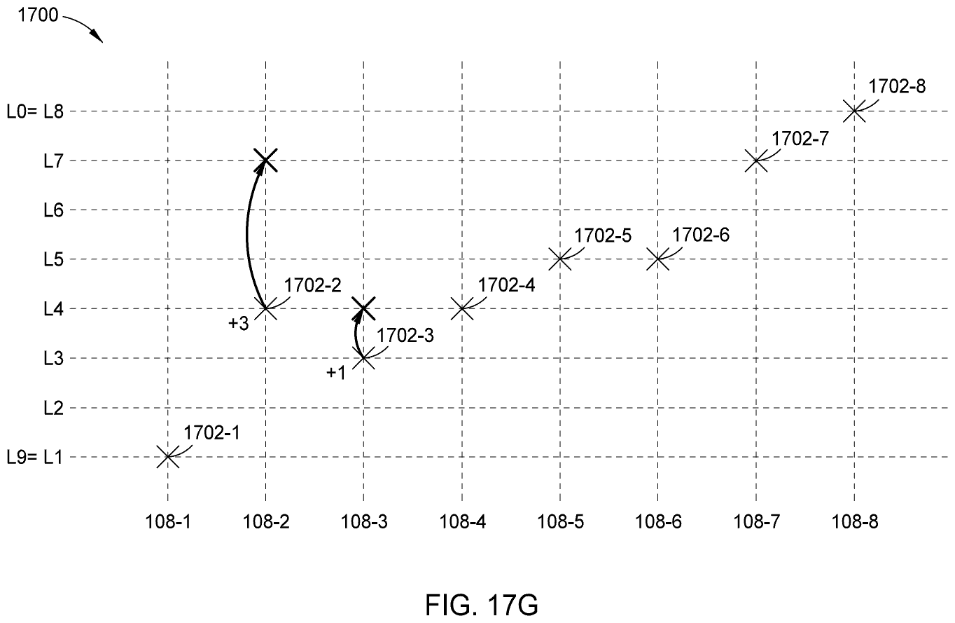

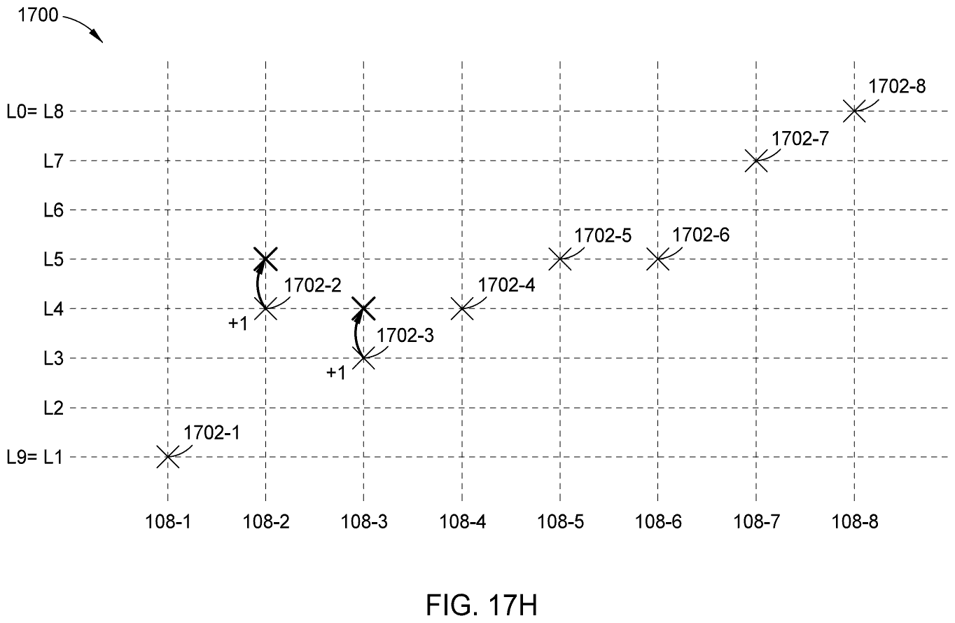

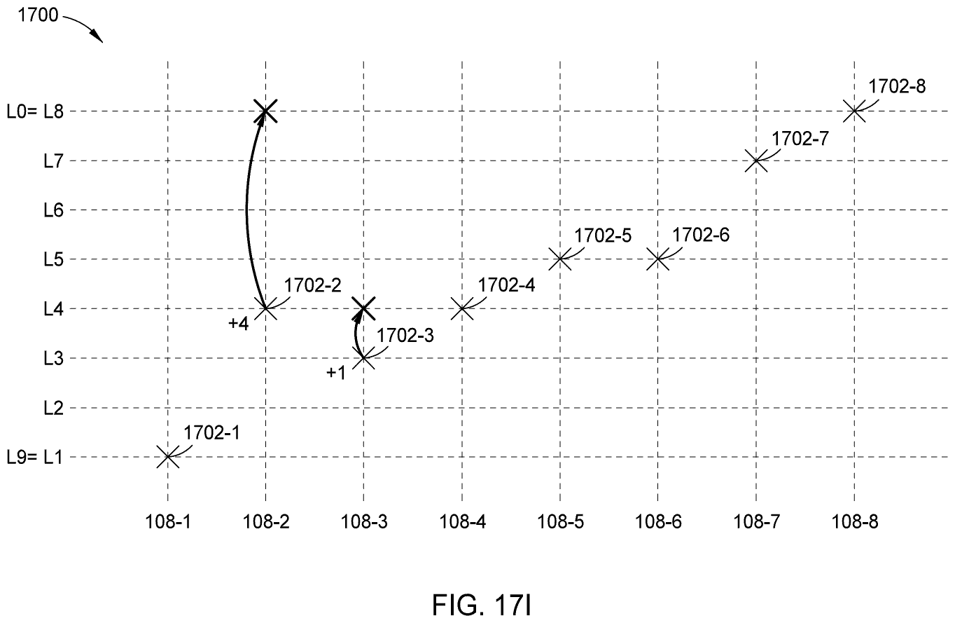

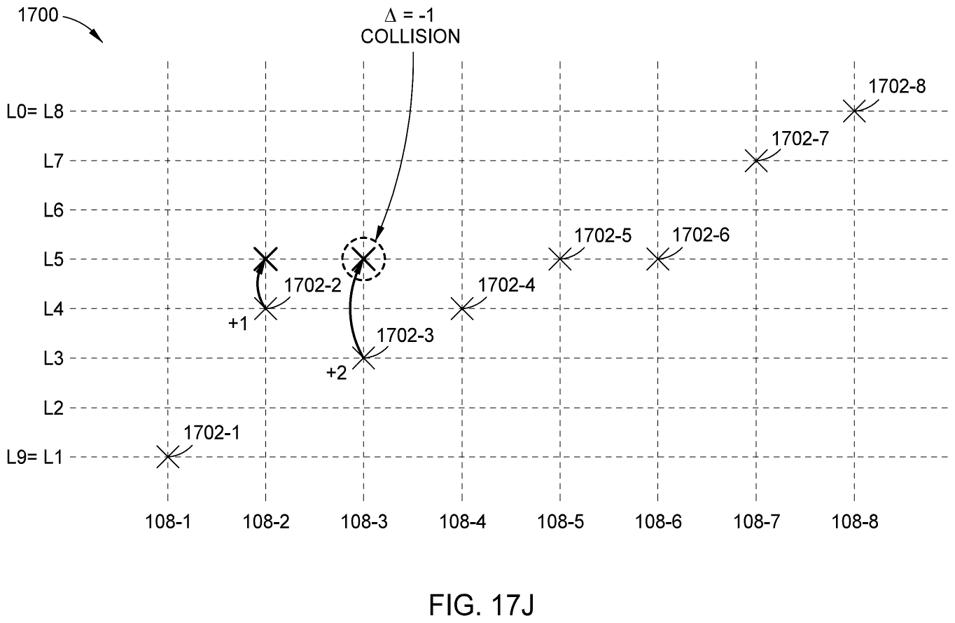

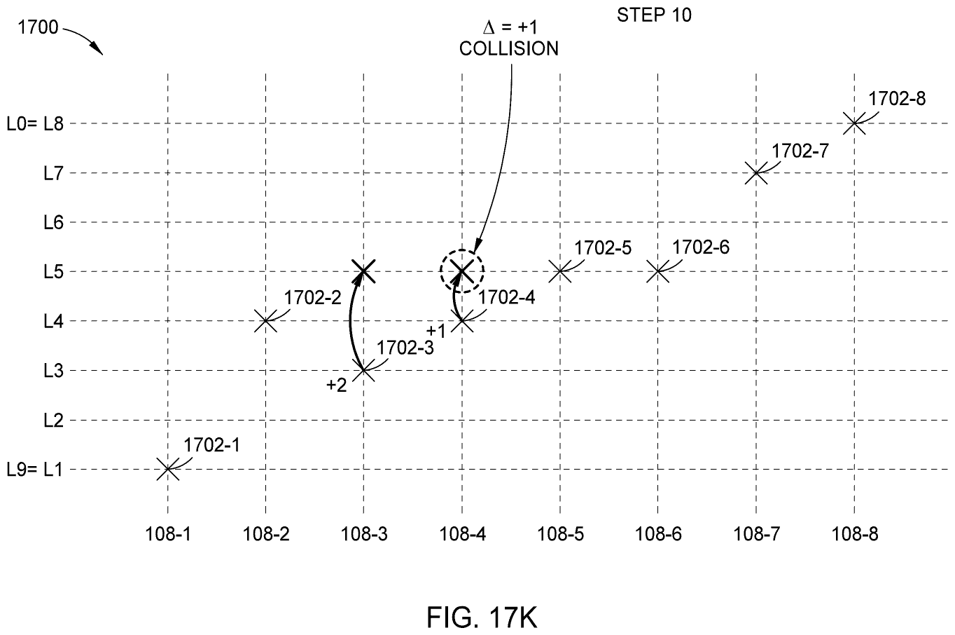

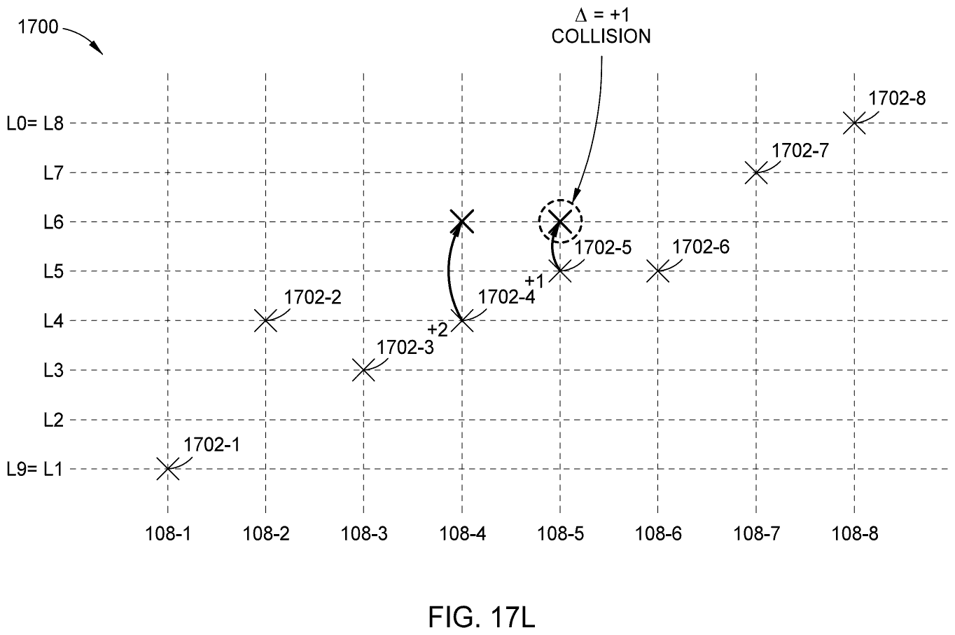

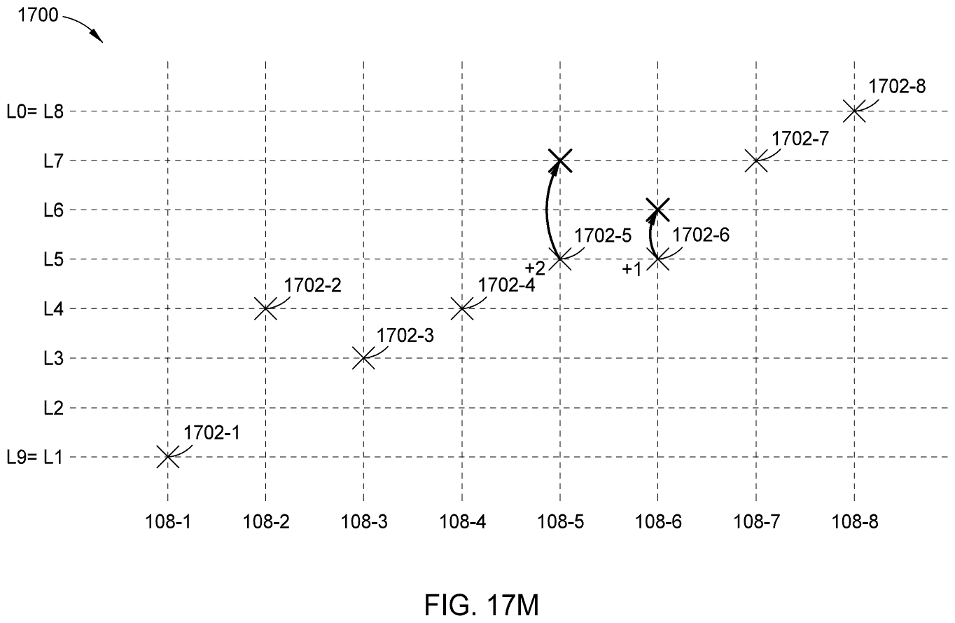

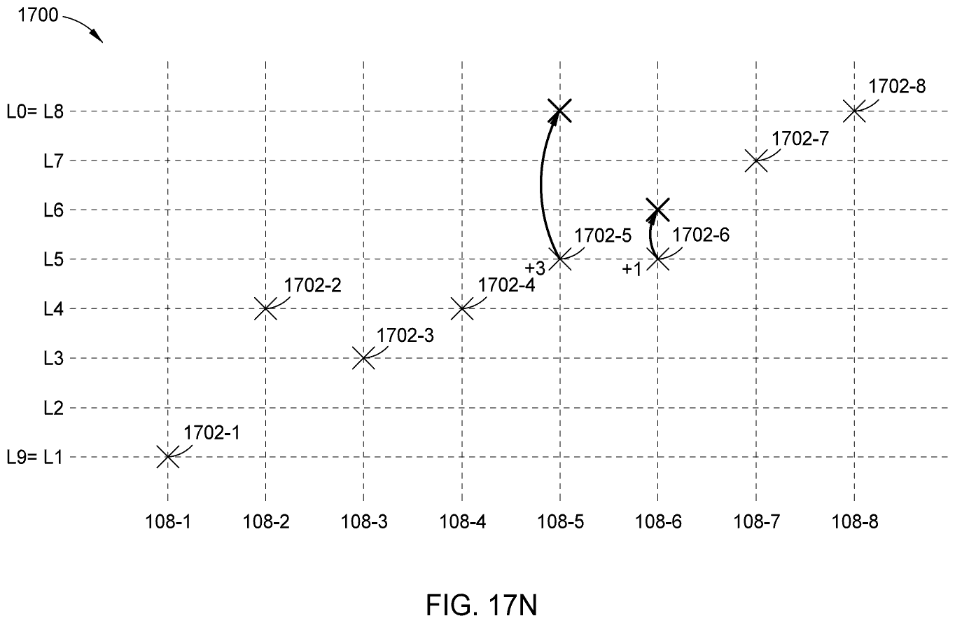

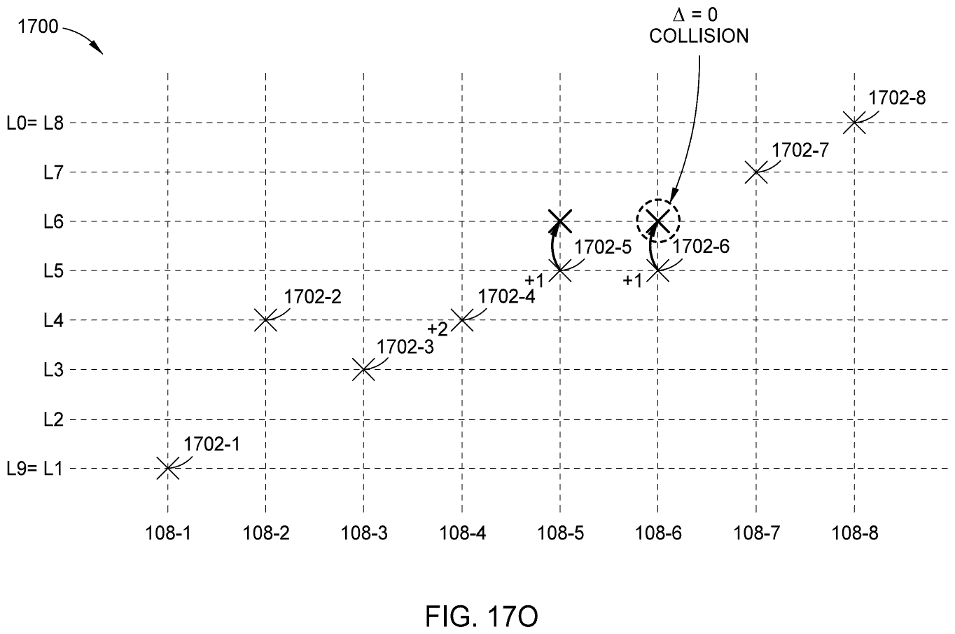

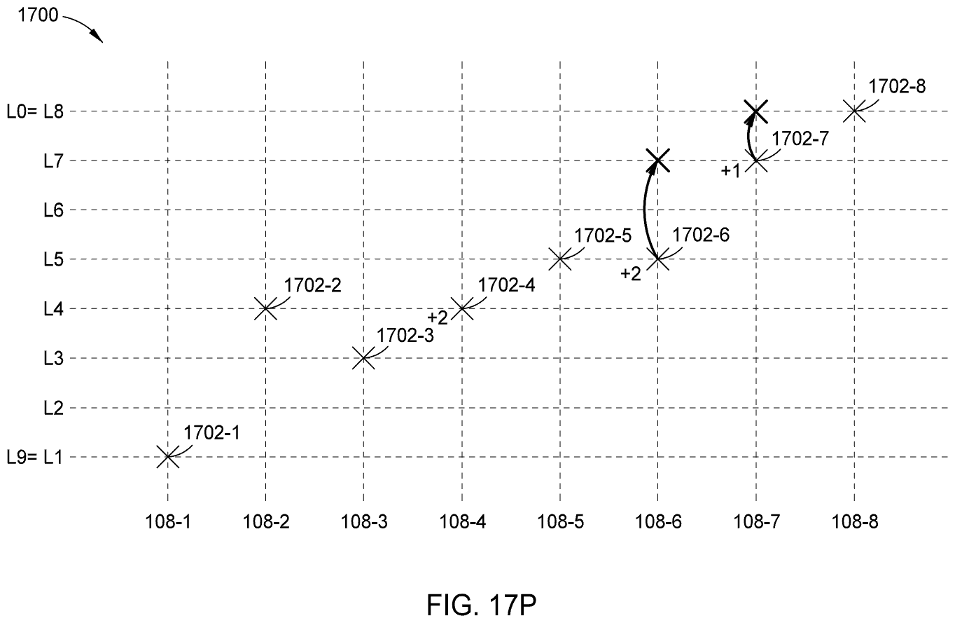

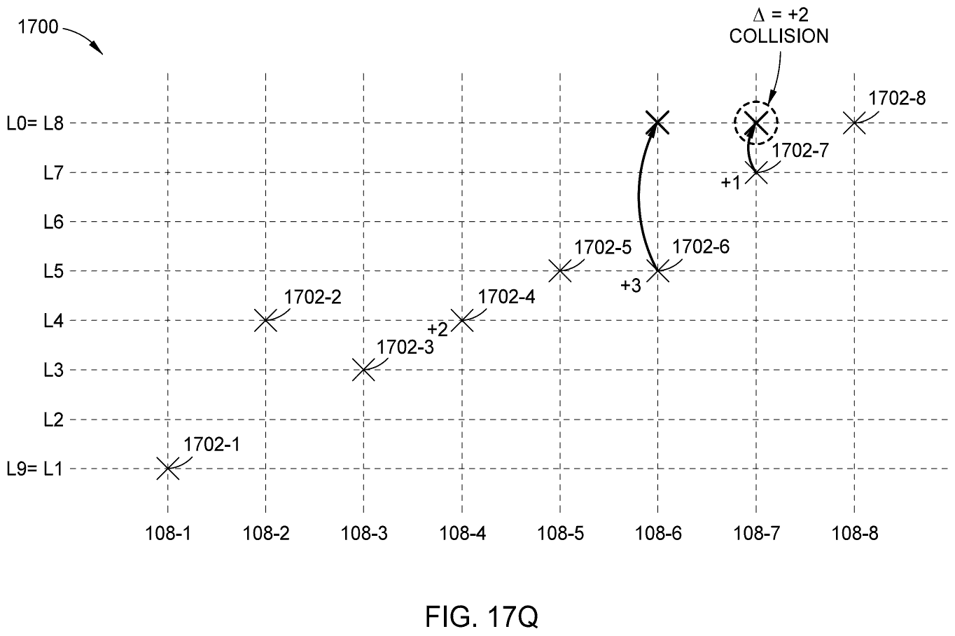

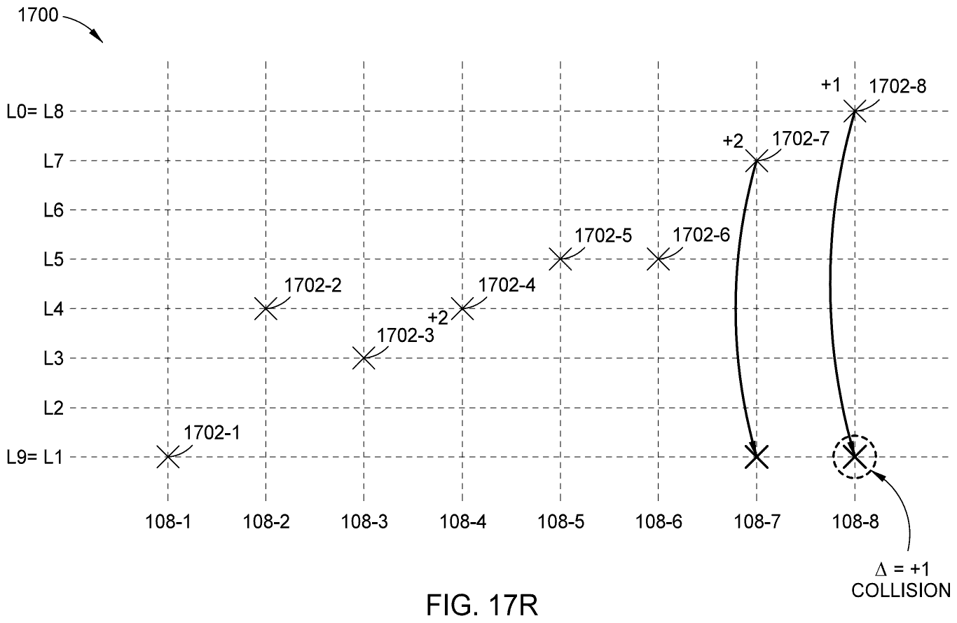

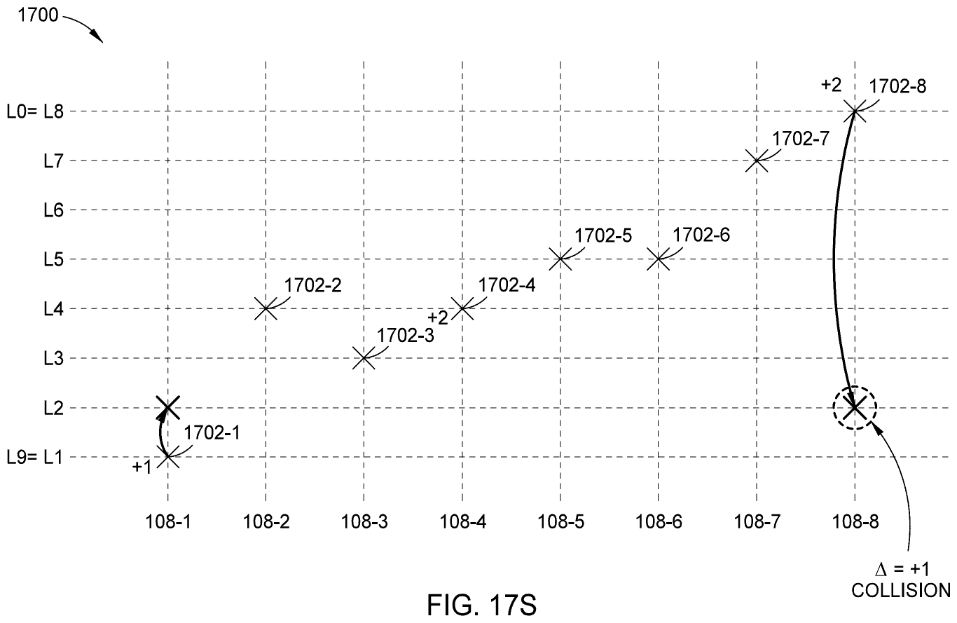

FIGS. 17A through 17S depict construction of a collision array based on method 1500, according to an embodiment. FIGS. 17A through 17S depict a grid 1700 of initial placements 1702-1 through 1702-8 of MRMs 108-1 through 108-8 (i.e., at the respective lowest remaining heater settings). FIGS. 17B through 17E depict collision detection for MRM pair 108-1 and 108-2 (i.e., a first iteration of 1506 through 1514 of method 1500). FIGS. 17F through 17J depict collision detection for MRM pair 108-2 and 108-3 (i.e., a second iteration of 1506 through 1514 of method 1500). FIG. 17K depicts collision detection for MRM pair 108-3 and 108-4 (i.e., a third iteration of 1506 through 1514 of method 1500). FIG. 17L depicts collision detection for MRM pair 108-4 and 108-5 (i.e., a fourth iteration of 1506 through 1514 of method 1500). FIGS. 17M through 170 depict collision detection for MRM pair 108-5 and 108-6 (i.e., a fifth iteration of 1506 through 1514 of method 1500). FIGS. 17P and 17Q depict collision detection for MRM pair 108-6 and 108-7 (i.e., a seventh iteration of 1506 through 1514 of method 1500). (i.e., a second iteration of 1506 through 1514 of method 1500). FIG. 17R depicts collision detection for MRM pair 108-7 and 108-8 (i.e., an eighth iteration of 1506 through 1514 of method 1500). FIG. 17S depicts collision detection for MRM pair 108-8 and 108-1 (i.e., 1516 and 1518 of method 1500).

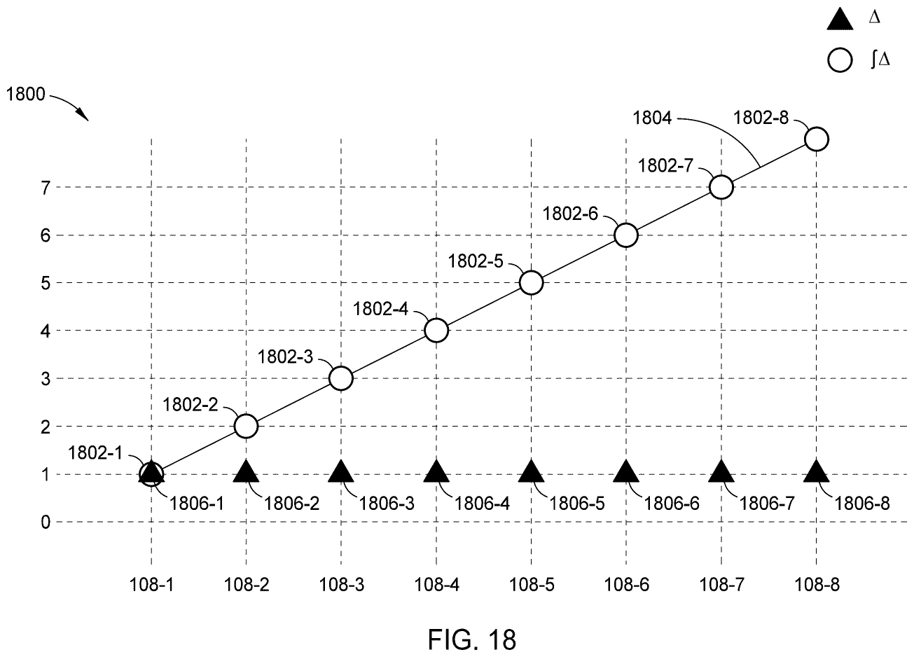

Ordered placement and sorted placement are described below. FIG. 18 depicts a graph 1800 of MRM alignments, according to an embodiment. Graph 1800 includes integral points 1802-1 through 1802-8 (collectively, integral points 1802) that represent integrals of heater settings (i.e., y-axis) for initial placements of MRMs 108-1 through 108-8. The example of FIG. 18 represents a situation in which MRMs 108-1 through 108-8 resonate at wavelengths of respective optical signals 112-1 through 112-8 (i.e., adjacent MRMs are spaced by one wavelength/channel). The example of FIG. 18 may be referred to as an ideal situation. Subtracting a ramp line 1804 from integral points 1602 results in a delta line of all ones, depicted here as points 1806-1 through 1806-8, which means that there is no need to adjust the heater settings of the MRMs. Less-ideal situations are addressed below.

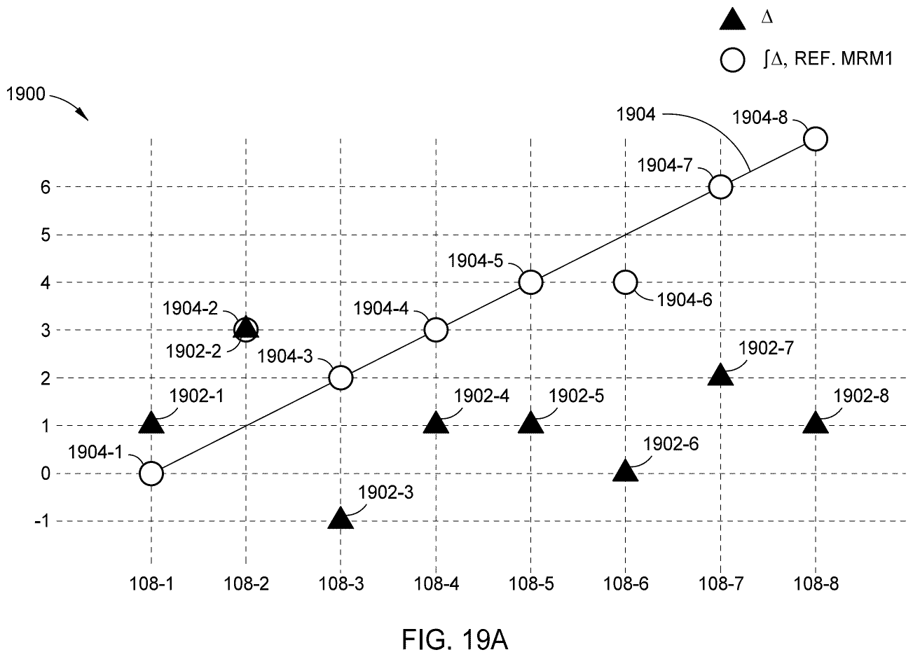

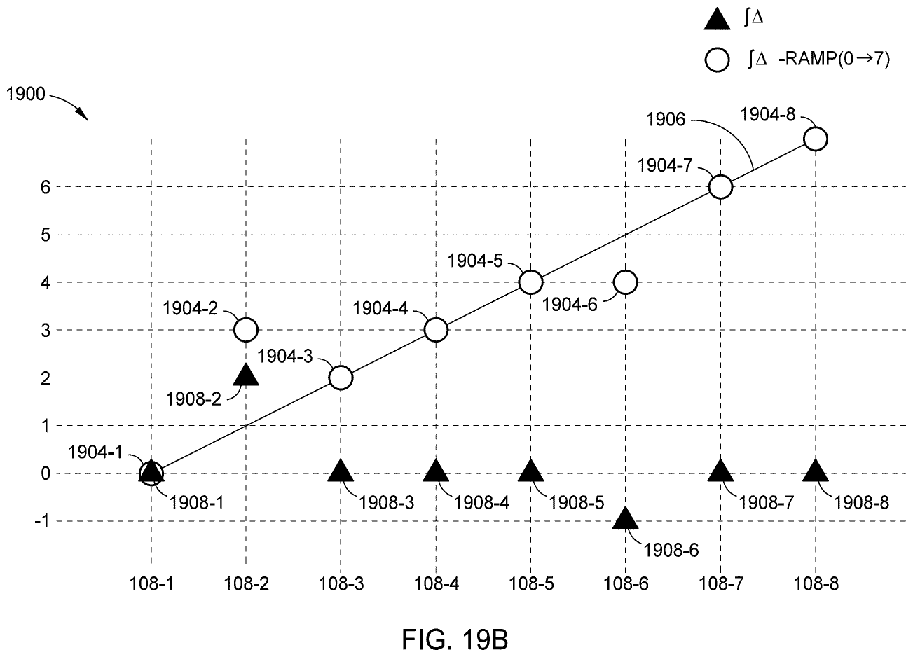

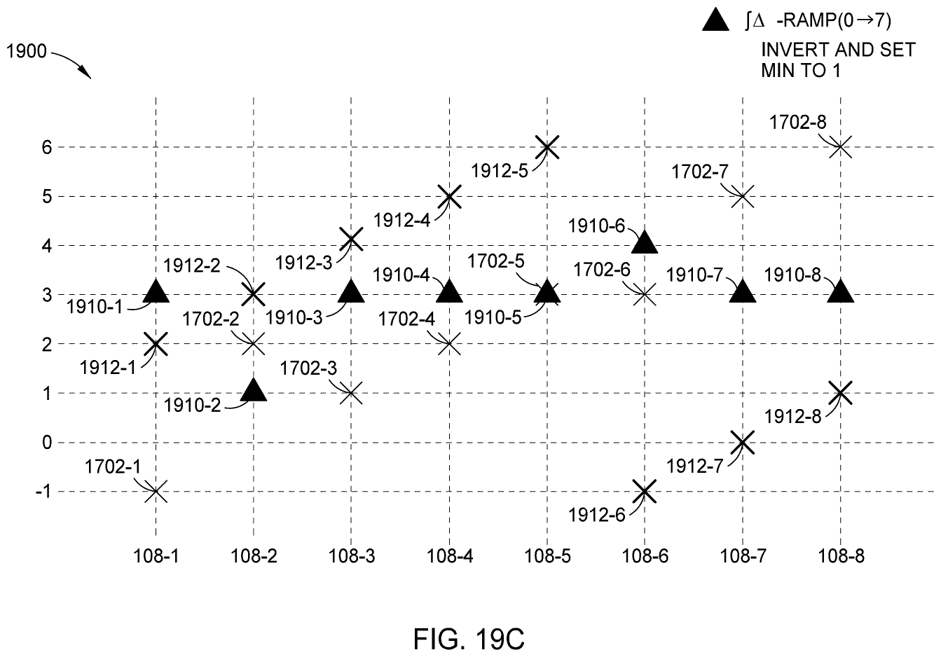

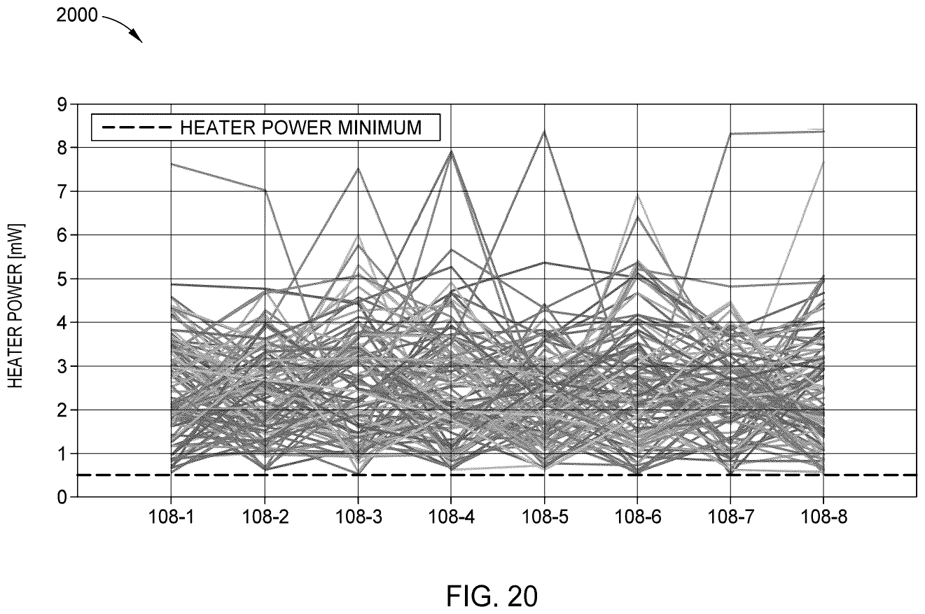

Ordered placement is described below with reference to FIGS. 19A through 19C, FIG. 20, and Table 1, for the example initial placements depicted in FIG. 17A.

TABLE 1
Ordered Placement Example

| | MRMs 108-1 through 108-8 |
|---|---|
| Initial placements 1702-1 | {−1, 2, 1, 2, 3, 3, 5, 6} |
| through 1702-2 | |
| Distances of Placements | {x, 3, −1, 1, 1, 0, 2, 1} |
| Integration of the Distances | {0, 3, 2, 3, 4, 4, 6, 7} |
| Integration-Ramp Δ | {0, 2, 0, 0, 0, −1, 0, 0} |
| Inverted Placements | {[0, −2, 0, 0, 0, 1, 0, 0} |
| Set Minimum Heater Settings | {3, 1, 3, 3, 3, 4, 3, 3} |
| (e.g., 1, or 3 in this example) | |
| Adjusted Placements based on | {2, 3, 4, 5, 6, −1, 0, 1} |
| Minimum (i.e., final placement) | |

With ordered placement, calibration system 102 selects heater settings from the remaining off-peak heater settings of MRMs 108, to lock MRMs 108 to wavelengths of respective optical signals 112. In other words, MRM 108-1 locks to the wavelength of optical signal 112-1, MRM 108-2 locks to the wavelength of optical signal 112-2, et cetera, and MRM 108-n locks to the wavelength of optical signal 112-n.

FIG. 19A depicts heater settings 1902-1 through 1902-2 (i.e., y-axis) for the initial placements of MRMs 108-1 through 108-8, and corresponding integral points 1904-1 through 1904-8, according to an embodiment. In the example of FIG. 17A, mismatches amongst MRMs 108 are relatively large, which results in relatively scattered heater settings 1902-1 through 1902-2.

FIG. 19B depicts integral points 1904-1 through 1904-8, and a ramp line 1906. Subtracting ramp line 1906 from integral points 1904 results in points 1908-1 through 1908-8, which do not form a delta line of all ones. The deviation represents offsets to be applied to heater settings 1902-1 through 1902-2. The offsets may be determined by inverting results of the subtraction (i.e., points 1908), and shifting the inverted results to provide a desired minimum heater setting, as depicted in FIG. 19C.

FIG. 19C depicts ordered placements of MRMs 108-1 through 108-8, according to an embodiment. FIG. 19C includes original placements 1702 of MRMs 108-1 through 108-8. Points 1910-1 through 1910-8 represent points 1908-1 through 1908-8 of FIG. 19C, subsequent to inversion and shifting. Points 1912-1 through 1912-8 represent final placement of MRMs 108-1 through 108-8.

Ordered placement may be suitable for some situations. In other situations, ordered placement may result in relatively high calibrated heater settings for one or more of MRMs 108, such as illustrated in FIG. 20. FIG. 20 depicts graphs 2000 of simulated calibrated heater settings 128 determined for MRMs 108 based on ordered placement, according to an embodiment. Graphs 2000 represent respective simulation runs. Graphs 2000 differ from graphs 1400 in that relatively high heater settings in graphs 2000 are distributed amongst multiple MRMs, whereas relatively high heater settings in graphs 1400 are concentrated amongst later MRMs.

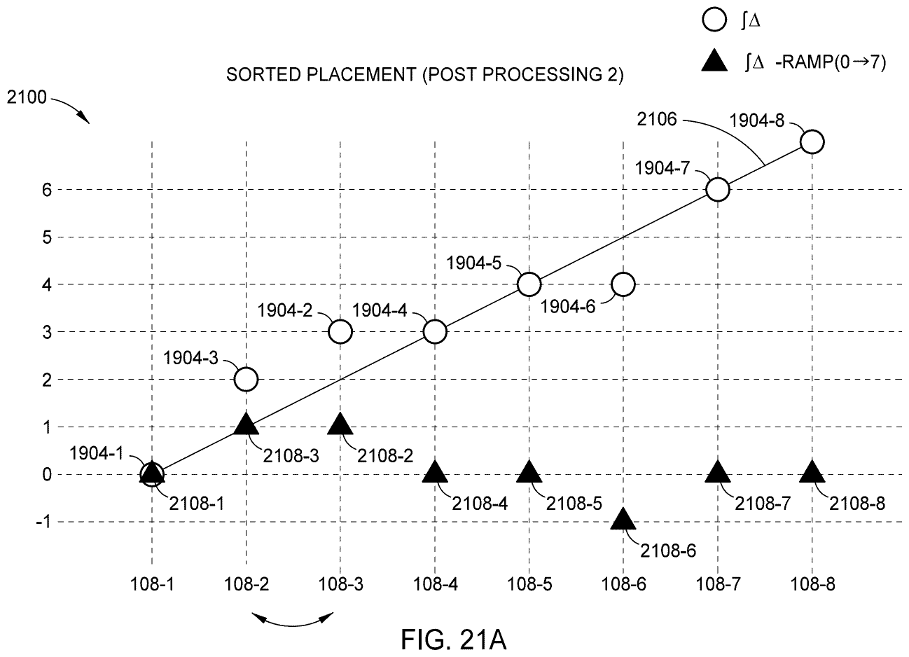

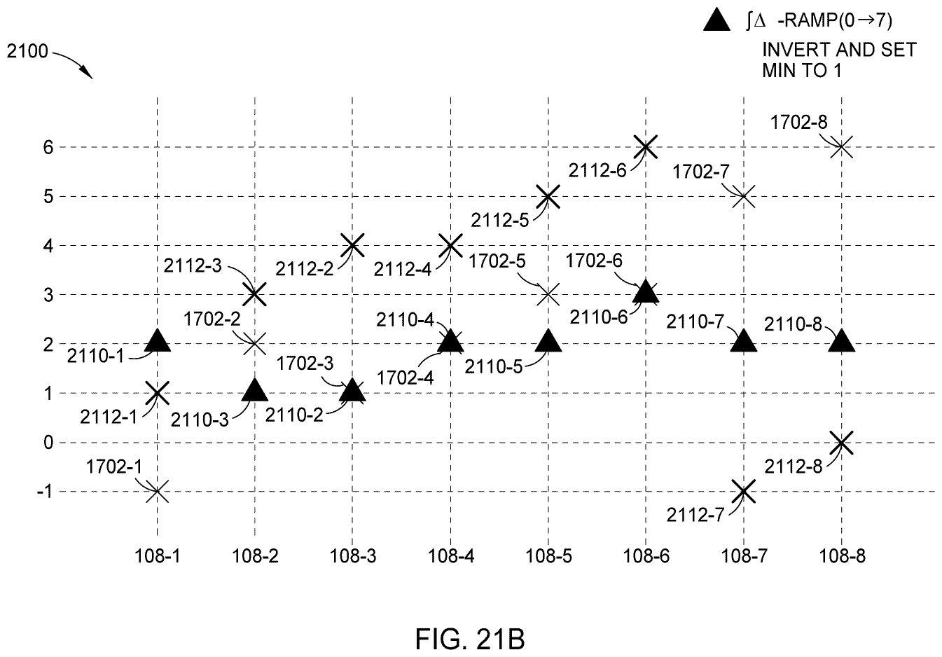

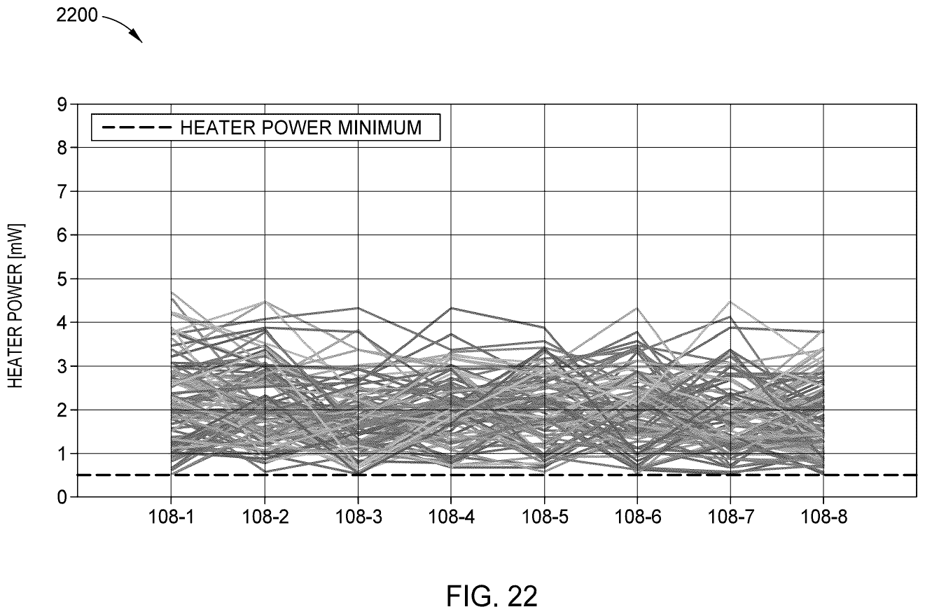

Sorted placement is described below with reference to FIGS. 21A and 21B, FIG. 22, and Table 2, for the example initial placements depicted in FIG. 17A.

TABLE 2
Sorted Placement Example

| | MRMs 108-1 through 108-8 |
|---|---|
| Initial placements 1702-1 | {−1, 2, 1, 2, 3, 3, 5, 6} |
| through 1702-2 | |
| Initial Distances | {x, 3, −1, 1, 1, 0, 2, 1} |
| | (−1 indicates M2 and M3 |
| | are in reverse sequence) |
| Revised placements | {−1, 1, 2, 2, 3, 3, 5, 6} |
| Revised Distances | {x, 2, 1, 0, 1, 0, 2, 1} |
| Integration of Revised Distances | {0, 2, 3, 3, 4, 4, 6, 7} |
| Integration-Ramp Δ | {0, 1, 1, 0, 0, −1, 0, 0} |
| Inverted Placements | {0, −1, −1, 0, 0, 1, 0, 0} |
| Set Minimum Heater Settings | {2, 1, 1, 2, 2, 3, 2, 2} |
| (e.g., 1, or 2 in this example) | |
| Adjusted Placements based on | {1, 3, 2, 4, 5, 6, 7 or −1, |
| Minimum (i.e., final placement) | 8 or 0} |

With sorted placement, calibration system 102 sorts the MRM sequence based on the initial distances, such that the MRMs are assigned calibrated heater settings that lock each MRM 108 to the nearest channel, not necessarily based in the order of increasing wavelengths of optical signals 112, and such that no pair of MRMs 108 is assigned collision/prohibited heater settings.

FIG. 21A depicts a graph 2100 of integral points 1904 of FIG. 19A, where integral points 1904-2 and 1904-3 of MRMs 108-2 and 108-3 are swapped based on sorted placement, according to an embodiment. In other words, sorting has reassigned/swapped MRMs 108-2 and 108-3 such that MRM 108-2 resonates at the wavelength of optical signal 112-3, and MRM 108-2 resonates at the wavelength of optical signal 112-3. Subtracting a ramp line 2106 from integral points 1904-1 through 1904-1 provide points 2108-1 through 2108-8.

FIG. 21B depicts sorted placements of MRMs 108-1 through 108-8, according to an embodiment. FIG. 21B includes original placements 1702 of MRMs 108-1 through 108-8. FIG. 21B further includes points 2110-1 through 2110-8 that represent points 2108-1 through 2108-8 of FIG. 21A subsequent to inversion and shifting. Points 2112-1 through 2112-8 represent final placement of MRMs 108-1 through 108-8.

FIG. 22 depicts graphs 2200 of simulated calibrated heater settings 128 determined for MRMs 108 based on sorted placement, according to an embodiment. Graphs 2000 represents respective simulation runs. Graphs 2200 differ from graphs 2000 (FIG. 20) in that heater settings in graphs 2200 are relatively low across all MRMs 108.

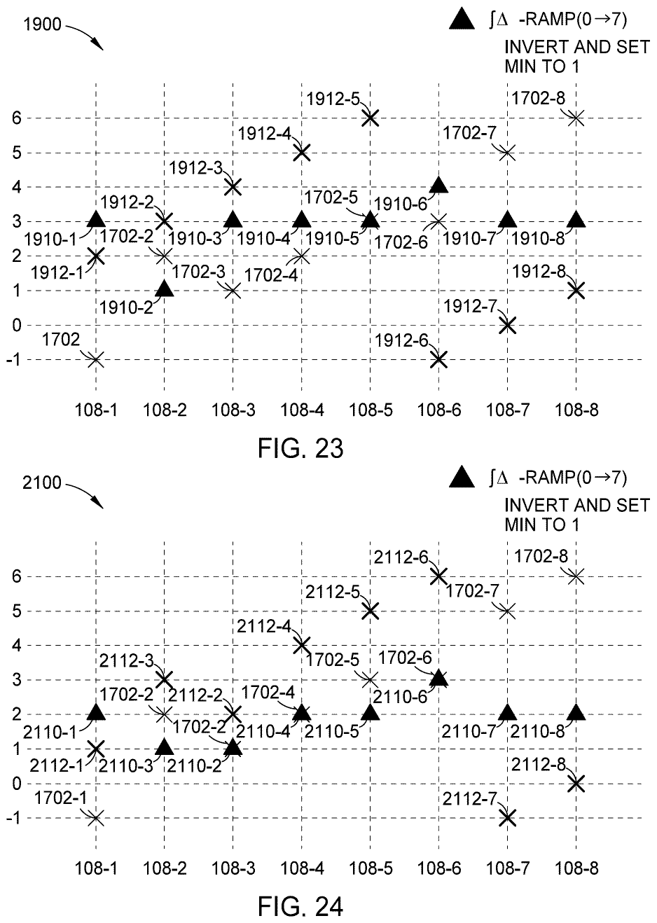

FIGS. 23 and 24 contrast results of sorted placement and ordered placement. FIG. 23 depicts graph 1900 of FIG. 19C. FIG. 24 depicts graph 2100 of FIG. 21B.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A method, comprising:
providing multiple optical signals to a waveguide that comprises multiple micro-ring modulators (MRMs):
sequentially sweeping heater settings of the MRMs, beginning with a first one of the MRMs nearest an input of the waveguide, from high to low;
recording drop-port outputs of the MRMs during the sweeping;
rendering each of the MRMs transparent to the optical signals subsequent to the sweeping the heater settings of the respective MRMs; and
selecting calibrated heater settings for the MRMs based on peak outputs of the respective MRMs that are determined based on the recorded drop-port outputs of the respective MRMs.

2. The method of claim 1, further comprising:
discarding off-peak heater settings that are below a tracking margin threshold;
wherein the selecting comprises selecting the calibrated heater settings for the MRMs from remaining ones of the off-peak heater settings of the respective MRMs.

3. The method of claim 2, further comprising,
applying lowest remaining off-peak heater settings of the MRMs to the respective MRMs; and
retaining the lowest remaining off-peak heater settings as the calibrated heater settings if the drop-port outputs of the MRMs meet a minimum output threshold.

4. The method of claim 2, further comprising,
applying a lowest remaining off-peak heater setting of the first MRM to the first MRM; and
for each subsequent one of the MRMs, applying a lowest remaining off-peak heater setting of the MRM to the MRM, selecting the lowest remaining off-peak heater setting of the MRM at the calibrated heater setting for the MRM if the drop-port output of the MRM meets a minimum output threshold, and incrementing the heater setting of the MRM to a next lowest remaining off-peak heater setting of the MRM until the drop-port output of the MRM meets the minimum output threshold.

5. The method of claim 2, further comprising, for each pair of the MRMs:
setting the heater settings of a subsequent MRM of the pair to a lowest remaining off-peak heater settings of a preceding MRM of the pair; and
cycling the heater setting of a preceding MRM of the pair through the remaining off-peak heater settings of the preceding MRM until the drop-port output of the subsequent MRM does not meet a minimum output threshold;
wherein the selecting further comprises selecting the calibrated heater settings for the MRMs from the remaining off-peak heater settings of the respective MRMs using relative channel spacing between the pair of MRMs that are determined based on the heater settings of the pair of MRMs at which the drop-port output of the subsequent MRM does not meet the minimum output threshold.

6. The method of claim 5, wherein the selecting further comprises:
selecting the calibrated heater settings for the MRMs from the remaining off-peak heater settings of the respective MRMs such that none of the pairs of MRMs are assigned the heater settings at which the drop-port output of the subsequent MRM does not meet the minimum output threshold.

7. The method of claim 6, wherein the selecting further comprises:
populating a collision array with the relative channel spacings; and
selecting the calibrated heater settings for the MRMs based on an ordered placement of entries of the collision array.

8. The method of claim 6, wherein the selecting further comprises:
selecting the calibrated heater settings for the MRMs from the remaining off-peak heater settings of the respective MRMs such that the first MRM is resonant at a lowest wavelength of the optical signals, and subsequent ones of the MRMs are resonant at correspondingly higher wavelengths of the optical signals.

9. The method of claim 6, wherein the selecting further comprises:
populating a collision array with the relative channel spacings;
sorting the collision array; and
selecting the calibrated heater settings for the MRMs from the remaining off-peak heater settings of the respective MRMs based on a sorted placement of entries of the collision array.

10. The method of claim 6, wherein the selecting further comprises:
populating a collision array with the relative channel spacings;
sorting the collision array; and
selecting the calibrated heater settings for the MRMs from the remaining off-peak heater settings of the respective MRMs based on a sorted placement of entries of the collision array, such that the MRMs are resonant at channels associated with lowest remaining off-peak heater settings of the MRMs.

11. A system, comprising:
a processor; and
memory comprising instructions to cause the processor to:
control lasers to provide optical signals to a waveguide that comprises cascaded micro-ring resonators (MRMs);
control a heater controller to sweep heater settings of each MRM, from high to low;
render each of the MRMs transparent to the optical signals subsequent to controlling the heater controller to sweep heater settings of the respective MRMs;
record drop-port outputs of the MRMs for the corresponding heater settings;
record peak outputs of the MRMs based on the recorded drop-port outputs of the respective MRMs;
discard off-peak heater settings that are below a tracking margin threshold; and
select calibrated heater settings for the MRMs from remaining ones of the off-peak heater settings of the respective MRMs.

12. The system of claim 11, wherein the memory further comprises instructions to cause the processor to:
select the calibrated heater settings for the MRMs from the remaining off-peak heater settings of the respective MRMs such that the first MRM is resonant at a lowest wavelength of the optical signals, and subsequent ones of the MRMs are resonant at correspondingly higher wavelengths of the optical signals.

13. The system of claim 11, wherein the memory further comprises instructions to cause the processor to:
record distances between adjacent pairs of MRMs based on collision heater settings, from the remaining off-peak heater settings, that cause collisions between the adjacent pairs of MRMs; and
select the select calibrated heater settings based on the distances.

14. The system of claim 13, wherein the memory further comprises instructions to cause the processor to:
integrate the distances;
subtract a ramp line from the integrated distances;
invert results of the subtraction;
shift the inverted results based on a minimum heater setting; and
select the select calibrated heater settings based on the shifted inverted results, such that a first one of the MRMs, closest to an input of the waveguide, resonates at a lowest wavelength of the optical signals, and subsequent ones of the MRMs resonate at respective increasing wavelengths of the optical signals.

15. The system of claim 13, wherein the memory further comprises instructions to cause the processor to:
integrate the distances;
sort the integrated distances based on the integrated distances;
subtract a ramp line from the sorted integrated distances;
invert results of the subtraction;
shift the inverted results based on a minimum heater setting; and
select the select calibrated heater settings based on the shifted, inverted results.

16. The system of claim 11, wherein the memory further comprises instructions to cause the processor to:
select the calibrated heater settings for the MRMs from the remaining off-peak heater settings of the respective MRMs such that no adjacent pairs of MRMs are assigned collision heater settings that cause collisions between the corresponding adjacent pair of MRMs.

17. A non-transitory computer readable medium encoded with a computer program that comprises instructions to cause a processor to:
control lasers to provide optical signals to a waveguide that comprises cascaded micro-ring resonators (MRMs);
control a heater controller to sweep heater settings of each MRM, from high to low;
render each of the MRMs transparent to the optical signals subsequent to controlling the heater controller to sweep the heater settings of the respective MRMs;
record drop-port outputs of the MRMs for the corresponding heater settings;
record peak outputs of the MRMs based on the recorded drop-port outputs of the respective MRMs;
discard off-peak heater settings that are below a tracking margin threshold;
record distances between adjacent pairs of MRMs based on collision heater settings, from remaining ones of the off-peak heater settings, that cause collisions between the adjacent pairs of MRMs; and
select calibrated heater settings for the MRMs from remaining ones of the off-peak heater settings of the respective MRMs based on the distances.

18. The non-transitory computer readable medium of claim 17, wherein the instructions further cause the processor to:
integrate the distances;
subtract a ramp line from the integrated distances;
invert results of the subtraction;
shift the inverted results based on a minimum heater setting; and
select the select calibrated heater settings based on the shifted inverted results, such that a first one of the MRMs, closest to an input of the waveguide, resonates at a lowest wavelength of the optical signals, and subsequent ones of the MRMs resonate at respective increasing wavelengths of the optical signals.

19. The non-transitory computer readable medium of claim 17, wherein the instructions further cause the processor to:
integrate the distances;
sort the integrated distances based on the integrated distances;
subtract a ramp line from the sorted integrated distances;
invert results of the subtraction;
shift the inverted results based on a minimum heater setting; and
select the select calibrated heater settings based on the shifted, inverted results.

20. The non-transitory computer readable medium of claim 17, wherein the instructions further cause the processor to:
select the calibrated heater settings for the MRMs from the remaining off-peak heater settings of the respective MRMs such that none of the pairs of MRMs are assigned the collision heater settings.
